(19) United States
(12) Patent Application Publication
(10) Pub. No.: US 2017/0366467 A1
(43) Pub. Date: Dec. 21, 2017

(54) DATA TRAFFIC CONTROL

(71) Applicant: INSPEED NETWORKS, INC., Los Altos, CA (US)

(72) Inventors: Kevin Martin, Los Altos, CA (US); Edwin Basart, Los Altos, CA (US); Michael R. Jordan, American Canyon, CA (US); Kent Fritz, Mountain View, CA (US); Michael Tovino, Bend, OR (US)

(21) Appl. No.: 15/691,289

(22) Filed: Aug. 30, 2017

Related U.S. Application Data
(63) Continuation-in-part of application No. 15/148,469, filed on May 6, 2016.
(60) Provisional application No. 62/276,607, filed on Jan. 8, 2016.

(51) Int. Cl. H04L 12/863; H04L 12/851; H04L 12/865; H04L 12/801; H04L 12/26; H04L 12/803

(52) U.S. Cl. CPC H04L 47/6215; H04L 47/6275; H04L 47/6265; H04L 47/29; H04L 47/24; H04L 47/125; H04L 47/122; H04L 43/0876

(57) ABSTRACT

As an example, a method includes storing, in non-transitory memory, prioritization rules that establish a priority preference for egress of data traffic for a first location. The first location includes a first location apparatus to control egress of data traffic for the first location apparatus and a second location apparatus at a second location, which is different from the first location, to receive data traffic and cooperate with the first apparatus to measure bandwidth with respect to the first location. The first location apparatus is coupled with the second location apparatus via at least one bidirectional network connection. The method also includes estimating capacity of the at least one network connection for the egress of data traffic with respect to the first location. The method also includes categorizing each packet in egress data traffic from the first location based on an evaluation of each packet with respect to the prioritization rules. The method also includes placing each packet in one of a plurality of egress queues associated with the at least one network connection at the first location apparatus according to the categorization of each respective packet and the estimated capacity. The method also includes sending the packets from the first location apparatus to the second location apparatus via a respective network connection according to a priority of the respective egress queue into which each packet is placed, such that the first location apparatus transmits at the estimated capacity for the egress of data traffic.

### CROSS-REFERENCE TO RELATED APPLICATION

This application is a continuation-in-part of U.S. patent application Ser. No. 15/148,469, filed 6 May 2016, and entitled BIDIRECTIONAL DATA TRAFFIC CONTROL, which claims the benefit of U.S. provisional application No. 62/276,607, filed 8 Jan. 2016, and entitled BIDIRECTIONAL TRAFFIC CONTROL OF DATA PACKETS, each of which is incorporated herein by reference in its entirety.

### TECHNICAL FIELD

This disclosure relates generally to systems and methods to provide traffic control for data packets.

### BACKGROUND

The last mile of the telecommunications network chain, which physically reaches the end-user's premises, is often the speed bottleneck in communication networks. That is, its bandwidth effectively limits the bandwidth of data that can be delivered to the end user. The type of physical medium that delivers the signals can vary according to the service provider. Examples of some physical media that can form the last mile connection for users can include copper wire (e.g., twisted pair) lines, coaxial cable lines, fiber cable and cell towers linking local cell phones to a cellular network. In a given communication network, the last mile links are the most difficult to upgrade since they are the most numerous and thus most expensive part of the system. As a result, there are abundant issues involved with attempting to improve communication services over the last mile.

Connectionless communication networks employ stateless protocols to individually address and route data packets. Examples of connectionless protocols include user datagram protocol (UDP) and internet protocol (IP). While these and other connectionless protocols have an advantage of low overhead compared to connection-oriented protocols, they include no protocol-defined way to remember where they are in a “conversation.” of message exchanges. Additionally, service providers implementing such protocols generally cannot guarantee that there will be no loss, error insertion, misdelivery, duplication, or out-of-sequence delivery of packets. These properties of connectionless protocols further complicate optimizations for communication sessions established between parties.

### SUMMARY

This disclosure relates to systems and methods to control data traffic for a site.

As one example, a method includes storing, in non-transitory memory, prioritization rules that establish a priority preference for egress of data traffic for a first location. The first location includes a first location apparatus to control egress of data traffic for the first location apparatus and a second location apparatus at a second location, which is different from the first location, to receive data traffic and cooperate with the first apparatus to measure bandwidth with respect to the first location. The first location apparatus is coupled with the second location apparatus via at least one bidirectional network connection. The method also includes estimating capacity of the at least one network connection for the egress of data traffic with respect to the first location. The method also includes categorizing each packet in egress data traffic from the first location based on an evaluation of each packet with respect to the prioritization rules. The method also includes placing each packet in one of a plurality of egress queues associated with the at least one network connection at the first location apparatus according to the categorization of each respective packet and the estimated capacity. The method also includes sending the packets from the first location apparatus to the second location apparatus via a respective network connection according to a priority of the respective egress queue into which each packet is placed, such that the first location apparatus transmits at the estimated capacity for the egress of data traffic.

As another example, an egress apparatus includes non-transitory memory to store data, the data including machine readable instructions and prioritization rules that establish a priority preference for egress of data traffic for a first location. The first location includes the egress apparatus to control egress of data traffic for the first location apparatus and an associated apparatus at another location, which is different from the first location. The associated apparatus receives data traffic and cooperates with the egress apparatus to measure bandwidth with respect to the first location, the first location apparatus being coupled with the associated apparatus via at least one network connection. One or more processors access the memory and execute the instructions that include a packet evaluator, a capacity calculator, a packet categorizer and packet routing control. The packet evaluator evaluates outbound data packets in outbound data traffic from the egress apparatus. The capacity calculator estimates capacity for each of the at least one network connections available for the outbound data traffic. The packet categorizer categorizes each of the outbound data packets based on the packet evaluation thereof with respect to the prioritization rules. The packet routing control places each of the outbound data packets in one of a plurality of egress queues at the egress apparatus according to the categorization of each respective packet and the estimated capacity to thereby control sending outbound packets from the egress apparatus to its associated apparatus at the estimated capacity via the at least one network connection according to the priority of the respective egress queue into which each of the outbound packets is placed.

### BRIEF DESCRIPTION OF THE DRAWINGS

FIG. 1 is a block diagram of a communication system implementing bi-directional traffic control.

FIG. 2 is a block diagram of an example of a link quality manager that can be utilized to control data traffic.

FIG. 3 is a block diagram illustrating an example of a session network assignment control.

FIG. 4 is an example of packet prioritization and routing that can be utilized to implement link quality management.

FIG. 5 is a block diagram illustrating an example of a communication system and some physical network connections to enable bi-directional traffic control for a site.

FIG. 6 is a block diagram of a communication system illustrating examples of tunneling connections for bidirectional communication.

FIG. 7 is a block diagram illustrating examples of data paths that can be implemented via the tunneling connections in the communication system of FIG. 6.

FIG. 8 is a block diagram illustrating an example of a communication system that includes multiple egress/ingress pairs to provide multiple stages of bi-directional traffic control between a site and a cloud data center.

FIG. 9 is a block diagram illustrating an example of an enterprise communication system with multiple egress/ingress pairs connected between different sites of the enterprise.

FIG. 10 is an example of controls for link quality management that can be implemented.

FIG. 11 is a flow diagram illustrating an example of a method to assign a network connection for a given session.

FIG. 12 is a flow diagram illustrating an example of a method of reassigning network connections for outbound traffic.

FIG. 13 is a flow diagram illustrating an example method of localizing quality issue relating to incoming traffic.

### DETAILED DESCRIPTION

This disclosure relates to systems and methods to control bidirectional data traffic for a site. As disclosed herein, this is achieved by controlling ingress and egress of data with respect to the site through a pair of distributed control apparatuses. For example, an egress control apparatus can be located at the site to control data egress from the site and a corresponding ingress control apparatus can be spaced apart from the site at a predetermined location to control ingress of data traffic to the site. The ingress control apparatus can be located in a cloud or other remote location from the site having a least one network connection to one or more high-bandwidth networks (e.g., the Internet). Each of the egress control apparatus and ingress control apparatus is configured to prioritize data packets that have been categorized as time sensitive and/or high-priority over other data packets. For example, the high-priority data packets can include interactive data traffic, such as voice data, interactive video, interactive gaming or time-sensitive applications. The egress control apparatus and ingress control apparatus for a given site cooperate with each other to provide bidirectional data traffic control for the given site in which higher priority data packets can be sent before other lower priority data packets, thereby maintaining a quality of service for predetermined types of traffic, such as including interactive media and other time-sensitive (e.g., real-time) traffic.

By way of example, each of the egress and ingress control apparatuses includes a link quality manager, which can be implemented at the operating system kernel level, to categorize and, in turn, determine a corresponding priority for each outbound data packet. Two or more queues can be configured to feed packets to each respective network connection, and there can be any number of one or more network connections. One of the queues is a high priority queue for sending traffic that the link quality manager categorizes as high priority traffic. Lower priority data packets can be placed in the other queue(s). The link quality manager prioritizes each of the data packets by placing it in a corresponding priority queue for sending the outbound packet to the other of the ingress/egress control apparatus. In this way, data packets categorized as high priority are place in the high priority queue and thus are sent before lower priority traffic, which is placed in other queues.

For example, in response to the user input to configure the priority of traffic, a plurality of packet categories can be established and the link quality manager can utilize the categories to categorize and prioritize traffic thus by splitting the routing functionality into separate egress/ingress control apparatus that exist at the site and then at the cloud, the prioritization can be implemented in a bidirectional manner. In some examples, the egress control apparatus and/or ingress control apparatus can be hosted as a virtual machine at a computing server (residing in the cloud). Thus by making interactive media (e.g., voice, video conferencing or other user defined applications) as high priority types of packets and by fixing the assignment of each respective session to a given communication link, the quality of the interactive or other user defined high priority types of traffic can be communicated bi-directionally at high quality relative to other approaches. Thus packets identified as time sensitive requiring specifically high priority are placed in high priority queues for faster communication than other types of traffic.

As mentioned, in some examples, an ingress or egress control apparatus can include more than one network connection for sending outbound data packets. To mitigate out of order and lost packets, the link quality manager implements session network assignment control to assign each session to a given one of the network connections. Packet prioritization and routing of data packets can be implemented for placing data packets in the appropriate priority queues implemented for each respective network connection. At each egress/ingress control apparatus for a given site, each outbound packet can be evaluated to determine if it matches an existing session. If no existing session is found, a new session can be created, such as by storing the session information in a corresponding session table.

In addition to the initial assignment for each respective session, the link quality manger can reassign an ongoing session under predetermined circumstances. For instance, in response to determining that capacity of a network has changed sufficiently to adversely affect transmission of high priority data packets (e.g., passive and/or active network quality measurements), the corresponding session can be reassigned from a current network connection to another network connection. A failure of a network connection can result in all sessions assigned to such failed network being reassigned. The reassignment can be implemented according to the same or a different assignment method than is implemented for the original assignment. For each network connection that is operational, the corresponding packet prioritization and routing can be implemented to ensure high priority outbound packets are effectively sent ahead of lower priority packets. Since the prioritization and routing is performed at each of the egress control apparatus and the ingress control apparatus, a high quality of the time sensitive data bi-directional traffic can be maintained for the site.

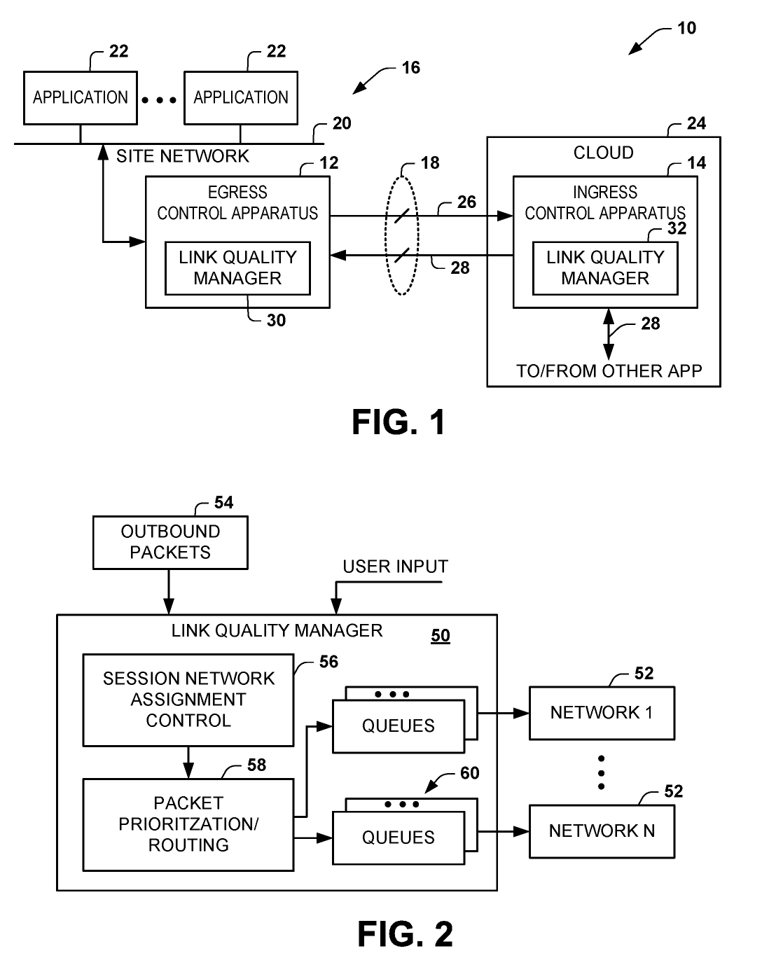

FIG. 1 depicts an example of a communication system 10 that includes an egress control apparatus (also referred to as a site apparatus) 12 and an ingress control apparatus (also referred to as cloud apparatus) 14 that are configured to cooperate for providing bi-directional traffic control for a corresponding site 16. As used herein, a site can refer to a location and/or equipment that can access one or more wide area network (WAN) connections 18. For example, a site can be an enterprise, such as an office, business or home that includes a set of computing devices associated with one or more users. As another example, a site can be an individual user, such as may have access to one or more data networks (e.g., WiFi network and/or cellular data network) via one or more devices, such as a smart phone, desktop computer, tablet computer, notebook computer or the like. When a user has access to the WAN via more than one device, each respective device can itself be considered a site within the scope of this disclosure. Thus, as used herein, the site can be an endpoint or an intermediate location of the network that is spaced apart from the ingress apparatus (i.e., the egress control apparatus 12 and the ingress control apparatus 14 defines an egress/ingress pair that can be distributed across any portion of the network). As a practical matter, the egress/ingress pair tends to realize performance improvements when located in the network across transitions (bottle necks) from high to low capacity or other locations that present quality and/or capacity issues.

The connections 18 can provide internet or other wide area connections according to a data plan associated with the site (e.g., via contract or subscription to one or more internet service providers). As an example, the connection 18 can provide data communications via a wired physical link (e.g., coaxial cable, digital subscriber line (DSL) over twisted pair, optical fiber, Ethernet WAN) or a wireless physical link (e.g., wireless metropolitan network (WIMAN), cellular network) for providing bi-directional data communications with respect to the site 16. Each such physical link can employ one or more physical layer technologies to provide for corresponding transmission of data traffic via each of the respective the connections 18. The egress control apparatus 12 thus is located at the site and communicates with the ingress control apparatus 14 via its one or more connections 18. For the example where the site is implemented as a smart phone or other mobile computing device, such smart phone device can include the site apparatus 12 implemented as hardware and/or software to control egress of traffic with respect to the site (e.g., smart phone), and the site apparatus cooperates with a corresponding ingress apparatus 14 that is configured to control ingress of traffic with respect to such site, as disclosed herein. Since the smart phone is portable, its physical connections 18 can change according to the available set of one or more connections (e.g., one or more cellular and/or one or more local wireless LAN) at a given location where the smart phone resides. In some examples, the same logical connections can be maintained between the ingress and egress apparatuses 12 and 14 as the portable device moves from one location to another.

In some examples, such as where the site provides data communication for a plurality of users and/or user devices, the site can also include a local site network 20. For example, one or more applications 22 can be implemented at the site 16 for communicating data with one or more other external applications (e.g., an end user application or service) via the site network 20 through the egress control apparatus 12. Such external application can be implemented within a corresponding computing cloud (e.g., a high speed private and/or public wide area network, such as including the internet). The corresponding computing cloud may be private or public, or at a private data center or on servers within another enterprise site. Each of the respective applications 22 can be implemented as machine executable instructions executed by a processor or computing device (e.g., the IP phone, tablet computer, laptop computer, desktop computer or the like).

As an example, the egress control apparatus 12 is communicatively coupled with the ingress control apparatus 14 via a tunnel on one or more network connections 18 of a network infrastructure. The tunnel encapsulates an application's egress packets with a new header that specifies the destination address of the ingress control apparatus 14, allowing the packet to be routed to the ingress control apparatus before going to its ultimate destination included in each of the egress packets. In other examples, the egress control apparatus 12 can send its outbound packets to another endpoint other than the ingress control apparatus. The egress control apparatus 12 operates to control outbound data packets that are sent from the site 16, such as from the applications 22, the network 20 or the apparatus itself to another resource (e.g., an application executing on a device, such as a computing device). Specifically, the egress control apparatus 12 controls sending data packets via one or more egress links 26 of the network connection 18. Similarly, the ingress control apparatus 14, which is located in the cloud or other remote network connection, controls and manages ingress of data packets to the site 16 via one or more ingress links 28 of the network connection 18.

For example, each of the egress link 26 and the ingress link 28 for the site 16 can include one or more network connections hosted by a contracted network service provider (e.g., an internet service provider (ISP)). Thus, when each of the links 26 and 28 include multiple different network connections, each link can provide an aggregate network connection having a corresponding aggregate bandwidth allocation that is made available from the set of service providers according to each respective service plan and provider capabilities, much of which is outside the control of the site. For example, a service plan for a given service provider can be designed to provide the site (e.g., a customer) an agreed amount of upload bandwidth and another amount of download bandwidth. The upload and download bandwidth agreed upon in the service provider contract thus constrains the amount of data traffic via the portion of the egress connection 26 and ingress connection 28 attributable to the service plan from the given service provider. When the egress and ingress connections involve multiple connections, the constraints on data traffic are summed across each of the connections. While a service provider may provide the agreed bandwidth in terms of maximum or “guaranteed” bandwidth, in practice, each of the connections 26 and 28 may have less bandwidth available due to external factors such as neighborhood traffic sharing network resources, and can become saturated with data which can result in interactive data, such as video or other media streams, developing excessive jitter and lost packets resulting in poor quality.

In some examples, the portion of the network 18 between the egress control apparatus 12 and the ingress control apparatus 14 can include the ‘last mile’ of the telecommunications network for customers, such as corresponding to or including the physical connection from the site 16 to the provider's main network high capacity infrastructure. It is understood that a particular length of a connection 18 between the egress control apparatus and ingress control apparatus are not necessarily literally a mile but corresponds to a physical or wireless connection between subscriber's site 16 and the service provider network. For instance, a portion of the network 18 thus can correspond to copper wire subscriber lines, coaxial service drops, and/or cell towers linking to cellular network connections (including the backhaul to the cellular provider's backbone network). Portions of the service provider's network beyond the last mile connection 18, which are demonstrated in the cloud at 28, as corresponding to the high-speed, high-bandwidth portion of the cloud 24. For example, egress control apparatus 12 is located at the site 16 generally at an end of the last mile link and the ingress control apparatus 14 is located on the other side of the last mile link, such as in the cloud 24 connected with one or more networks' high capacity infrastructure, corresponding to link 28.

While the foregoing example describes the egress apparatus at an enterprise site and the ingress apparatus at the other side of a last mile link, in other examples, the egress/ingress pair can be distributed at other locations of the network. For example, an egress/ingress pair 12, 14 can be provided across a peering point where separate WANs (e.g., internet networks) exchange bidirectional traffic between users of the network. As another example an egress/ingress pair 12, 14 can be provided across a portion of a backbone network that is known to exhibit congestion or failure. Thus, as used herein a given egress ingress pair can be provided across any portion of the network or across the entire network.

Each of the egress control apparatus 12 and the ingress control apparatus 14 can include hardware and machine-executable instructions (e.g., software and/or firmware) to implement a link quality manager 30 and 32, respectively. Each of the link quality managers 30 and 32 operate in the communication system to dynamically control outbound data traffic via each of the respective egress and ingress connections 26 and 28 by prioritizing how outbound data packets are sent across the link 18. As a result, the link quality managers 30 and 32 cooperate to provide bidirectional traffic control that realizes an increase in quality for interactive as well as other types of data that may be identified as being important to the user. The link quality manager 30 can provide traffic control for both egress and ingress data packets, which can be programmable in response to a user input. For example, a user can specify one or more categories of data packets that are designated high priority data packets to be sent out over the link 18 before other lower priority data packets. In a simple example, there may be two categories of data: high-priority data and low priority data. For example, interactive and other time-sensitive data can be categorized as having priority over other traffic that can be categorized as low priority traffic. The low priority data can correspond to data that is either explicitly determined to be low priority or correspond to traffic having no priority. There can be any number levels of priority for a different categorization for data packets.

In some examples where lower priority traffic is sent after high priority traffic (e.g., traffic categorized as interactive or time-sensitive), if the low priority queue becomes full (e.g., due to continually sending out high priority traffic via the network connection at or above current measured capacity), the low priority traffic may be dropped (e.g., discarded) from its queue. Additionally, as disclosed herein, packets may be dropped from a given queue to maintain transmission of egress data traffic at the measured capacity for one or more respective network connections. To mitigate having higher priority traffic starving a lower priority traffic over a given network connection, in some examples, the link quality manager 30, 32 may allocate a predetermined (fixed or programmable) minimum amount of the measured capacity to each of the queues associated with a given network connection.

As a further example, the link quality manager 30 sets a current rate limit for each network connection and transmits data to over each network connection at the current rate limit. For instance, the link quality manager 30 adjusts the rate limit for each network connection based on a quality metric for each respective connection. The quality metric for a given network connection may be a value that is derived from or includes latency, jitter and packet loss. In some examples, the quality metric for each network connection may be a binary value, such as is stored in memory to indicate good or bad quality for each connection. In other examples, different numbers of bits or dimensions of quality may be used for each connection. The quality metric for egress traffic sent from the egress control 12 apparatus via a given network connection may be determined by the ingress control apparatus 14 or other endpoint to which the traffic is sent. The ingress apparatus 14 or other endpoint may provide the egress apparatus 12 feedback indicative of determined quality metric. Alternatively or additionally, the egress control apparatus 12 may determine its own quality metric for egress traffic sent via a given network connection, and/or the ingress control apparatus 14 may determine its own quality metric for ingress traffic sent via a given network connection. For example, control apparatus 12 or 14 may determine its own quality metric by measuring latency, jitter and packet loss of round-trip traffic such as ICMP echo (ping), ICMP timestamp, UDP echo service, TCP echo service, or similar traffic.

The link quality manager 30 thus may employ the quality metric (e.g., a magnitude of individual latencies and/or other quality measures, such as jitter or dropped packets) to set a dynamic rate limit or it can set a stable rate limit for each network connection. As an example, the link quality manager 30 is configured to establish a dynamic rate limit for each network connection as intermediate rate limit adjustments when controlling quality dynamically, such as to compensate for changes in the quality metric. For instance, the link quality manager 30 implements dynamic bandwidth control to reduce the rate limit until for a given network connection where the bottleneck occurs within the egress apparatus 12 and no longer occurs in the external path associated with the given network connection. As a further example, for sake of efficiency, the link quality manager 30 reduces the rate limit for the given network connection to be just below the bottleneck of the network path (WAN) for such connection. The use of the dynamic rate limit or a static rate limit may be selected (by link quality manager 30) in response to a user input instruction. In another example, the link quality manager 30 is configured to set a stable rate limit, which defines a rate limit that produces a measure of good quality according to the quality metric.

As mentioned, in some communications systems, the network connection 18 includes a plurality of different, separate physical connections from one or more service providers. Given multiple distinct network connections, each link quality manager 30 and 32 is further programmed to assign each data flow to a corresponding session, and each session can be assigned to a respective one of the network connections, such as by specifying its network interface in the control apparatus 12 or 14. As used herein, a session refers to a persistent logical linking of two software application processes (e.g., running as machine executable instructions on a device), which enables them to exchange data over a time period. A given session can be determined strictly by examining source and destination IP addresses, source and destination port number, and protocol. For example, transmission control protocol (TCP) sessions are torn down using protocol requests, and the link quality manager closes a session when it sees the TCP close packet. As another example, user datagram protocol (UDP) packets are part of one-way or two-way sessions of traffic flow. A two-way session is identified in response to the link quality manager 30 detecting a return packet from a UDP session, and is closed when there is no activity for some prescribed number of seconds. Sessions that have no return packets are one-way and are closed after, typically, a shorter number of seconds. The operating system kernel for each apparatus 12, 14 thus can open and close sessions.

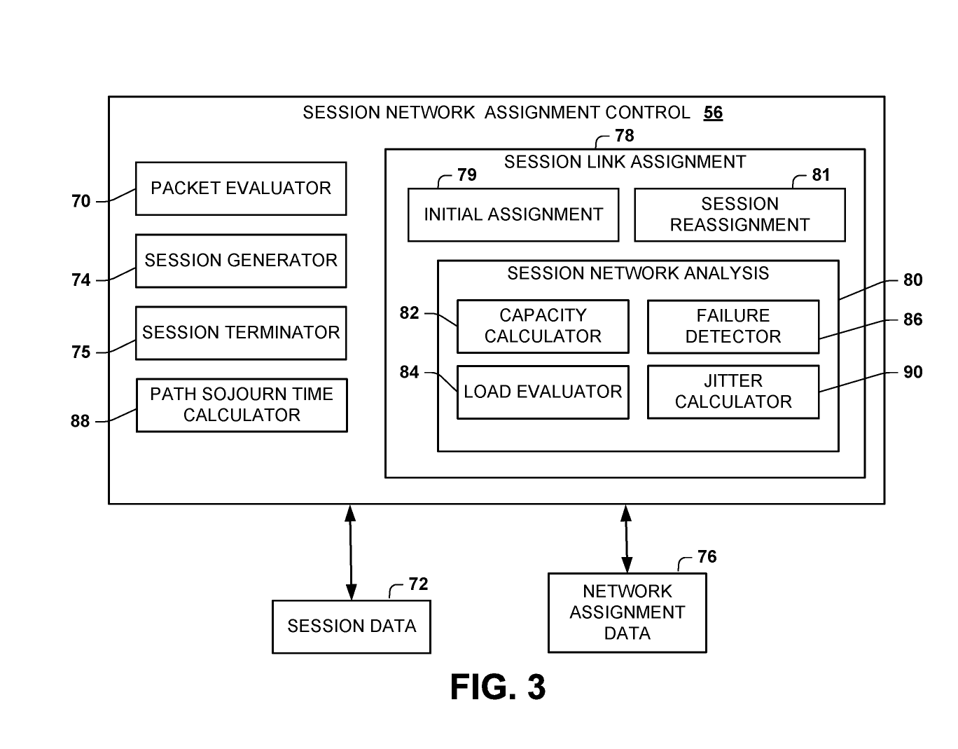

In some examples where a plurality of different network connections form the egress connection (e.g., an aggregate egress connection) 26 in the network 18, the link quality manager 30 can assign each session to a given network connection when it is created. Similarly, where a plurality of different network connections form the ingress connection (e.g., an aggregate ingress connection) 28 in the network 18, the link quality manager 32 assigns each new session to a given network connection. Typically, each respective session uses the same network connection for outbound and inbound traffic at each control apparatus 12, 14. The assignment of sessions to a network can be stored (e.g., as a sessions table or other data structure) in memory. The network assignment for each session remains fixed for all data packets in that session until, if circumstances warrant, the session is reassigned to another of the plurality of available networks in the aggregate connection. Examples of some approaches that the link quality manager can use to assign sessions to one of the network connections can include load balancing across the network connections, such as a round robin assignment, a capacity and/or load-based assignment (i.e., “weighted round robin”), a static performance determination or dynamic capacity determination (see, e.g., FIG. 3). The link quality manager 32 of the egress control apparatus 12 controls load balancing for both egress and ingress traffic. That is, because sessions are initiated from the egress side (e.g., by a user or other application), each connection 26 that is initiated on a network connection with egress traffic results in both egress and ingress traffic for the session via its respective network connection.

As a further example, there can be a plurality of queues implemented for each network connection 26 to enable categorization and prioritization of the outbound data packets to be sent from the site (e.g., by one of the applications 22) via a selected connection. As used herein, each queue can used by a network interface driver to retrieve the data packets for sending out via a respective network connection according to the established priority for its queues. The queues for each network connection can be configured by and operate within the operating system kernel to facilitate processing of the data packets (e.g., in real time). The queues can include a data structure in physical or virtual memory. For instance, each queue can store data packets in a first-in-first-out (FIFO) data structure. The actual data packets from the IP stack can be stored in the queue or, in other examples, the queue can contain pointers to the data packets in the IP stack. For instance each queue consists of descriptors that point to other data structures, such as socket kernel buffers that hold the packet data. Such other data structures can be used throughout the kernel for processing such packets. The network interface driver for each network connection prioritizes all data packets in the high priority queue by sending them via the network before packets in each lower priority queue.

In order to enable placement of data packets in the appropriate priority queues, the link quality manager 30, in kernel space (for efficiency purposes) or user-level application, categorizes each of the outbound data packets, such as provided from one or more of the applications 22. The categorization can be based upon predefined rules that are programmed (e.g., via a corresponding interface in user space) into the link quality manager 30 in response to a user input. In some examples, the user input can correspond to a set of default categorization rules, such as to prioritize interactive types of communication (e.g., voice communication, video communication and/or other interactive forms of communication). An example of information from data packets that can be analyzed by the link quality manager 30 for data categorization and resulting prioritization can include IP address (e.g., source and/or destination), port numbers, transport protocols, quality of service information (e.g., Differentiated Services Code Point (DSCP)), packet content and/or DNS queries. The link quality manager 30 can apply the rules to the analyzed information to ascertain a categorization for each data packet and, in turn, specify a corresponding level of prioritization queue into which the data packet is placed for sending out via the assigned network connection from the egress control apparatus 12 to the ingress control apparatus 14. In some examples, there may not be enough information within the packet itself, and the link quality manager may require additional packet analysis to determine whether or the packet is part of a high priority application's traffic and, based on such additional analysis prioritize such packet properly.

In some examples, the additional analysis is implemented by handing off the packet and associated kernel-level data to a user-level application (e.g., via a corresponding application program interface (API)). For example, the link quality manager 30 can interpret a SIP call setup request to determine the port number for a voice call, which preliminary information determined at the kernel level can be utilized by the user-level application along with other information obtained over one or a series of data packets for such session to categorize the session as a voice (e.g., high-priority) session. The user-level application may also determine a priority for such session, and then returns the categorization and/or priority information to the kernel via the API for further processing (e.g., by the kernel). This and other use of both kernel-level and user application to control prioritization and routing may be referred to as a hybrid approach. For the example of transmitting UDP packets, heuristics can be utilized by the link quality manager 30 to determine if the packet is voice (or another high-priority category). By interpreting other protocols, particular traffic can be correctly identified. For the example of SIP, the link quality manager 30 can identify a SIP packet and then in a subsequent SIP packet, the link quality manager 30 can ascertain a port number for the UDP traffic, which can be used to categorize the session with particularity. In some examples, the analysis of multiple packets associated with a given session of data traffic can be used to determine a behavior of the data traffic, which is used by the link quality manager 30 for prioritization and routing of packets, such as disclosed herein.

As mentioned, the link quality manager 30 transmits at the current rate limit that is set for each network connection and based on the established priority of packets that determines a queue into which each packet is placed. If aggregate throughput would exceed the rate limit for a given network connection, however, throughput of lower priority traffic is reduced. For instance, each priority level of traffic may have a predetermined minimum throughput level (e.g., a percentage of the total rate limit for a network connection), and the link quality manager 30 may reduce the actual throughput of the lower priority traffic until it reaches the minimum allowed. This reduction in throughput may result in such lower priority traffic being dropped; however, this minimum throughput helps prevents lower priority traffic from being starved by high rates of higher priority traffic. As disclosed herein, there may be many different priorities of data traffic for each (one or more) network connection, and data traffic in each priority class may be assigned a minimum percentage of the total rate limit for each network connection. For example, if the current aggregate throughput exceeds the rate limit for a given network connection, the throughput of the lowest priority class of data traffic is reduced first, followed by the next lowest, and so on. If the rate limit for a given network connection is reduced when one or more traffic classes have already been reduced to their minimum percentages, all priority classes of data traffic that are already at their minimum percentages are reduced proportionally to maintain their percentages of the rate limit applied to aggregate traffic on such network connection.

In response to data packets received from the egress control apparatus 12, the ingress control apparatus (in the cloud 24) removes packets from the tunnel, strips off the tunnel IP header, and performs a routing function to send the packet to the destination application according to the original packet header information (e.g., based on the defined destination address). This packet readdressing mechanism allows traffic to flow from the site application to its destination via the remote ingress apparatus 14. To enable receipt of incoming traffic originating from an external application to the cloud ingress control apparatus, instead of the application at the site, the site's application DNS can be modified (e.g., by the ingress or egress control apparatus, or the site administrator) to the IP address of the remote ingress control apparatus 14. Thus the site will receive incoming connections via the ingress control apparatus.

While the foregoing traffic flow was explained from the perspective of the link quality manager 30 at the egress control apparatus 12, the link quality manager 32 at the ingress control apparatus operates in a substantially similar manner with respect to the ingress data packets sent to the site (e.g., site applications 22). That is, the link quality manager 32 performs categorization and prioritization to send data packets to the egress control apparatus 12 via one or more network connections 28.

FIG. 2 depicts an example of a link quality manager 50 that can be utilized to control outbound data traffic over one or more network connections 52, demonstrated as networks 1 through N, where N is a positive integer. Thus, there can be one or more networks. The outbound traffic is provided in as outbound data packets (e.g., IP packets or other data units) 54, which can be provided to the link quality manager 50 from an application executing on a computing device (e.g., corresponding to applications 22). Thus, the type of data traffic will depend on the application that provides the data. The link quality manager 50 can correspond to the link quality manager 30 or 32 that is utilized in the egress/ingress control apparatus 12 or 14, respectively, disclosed with respect to FIG. 1. Thus, reference can be made back to FIG. 1 for additional context associated with how the link quality manager may be used in a communication system. In some examples, the functions of the link quality manager relating to moving a session from one network to another, as disclosed herein, can be implemented only at the site egress apparatus to facilitate session tracking and management, and the associated ingress control apparatus differs in that it is not required to move sessions to other networks. However, in situations where the ingress control apparatus also operates as an egress control apparatus, as part of another egress-ingress pair or as an egress apparatus (when viewed from its perspective), such functionality can be included as part its corresponding egress control apparatus.

The link quality manager 50 processes each outbound data packet 54, analyzes the packet and sends the packet out on a selected network 52 connection corresponding to a physical layer. In the example of FIG. 2, the link quality manager 50 includes a session network assignment control block 56. The session network assignment control block 56 can be implemented in hardware, software or firmware (e.g., corresponding to machine readable and executable instructions). Each outbound packet 54 either belongs to an existing session or is assigned to a new session. The session network assignment control 56 analyzes each packet to determine to which session the packet belongs or creates a new session if the packet is not part of an existing session. The network assignment control 56 selects which of the networks 52 for sending each data packet based on which network the corresponding session has been assigned (e.g., as described in network assignment data). If only one network 52 is available, all sessions would be assigned to such network for sending outbound packets.

As disclosed herein (see, e.g., FIG. 3), information in each packet can be evaluated to ascertain whether the packet has already been assigned to a session. If the analysis of a given packet data indicates that it belongs to an existing session, the network assignment control 56 identifies a network (e.g., by specifying a network interface) for the given packet, and the identified network is used in subsequent processing by packet prioritization and routing function 58. If the outbound packet 54 does not match an existing session, the session network assignment control block 56 creates a new session for that packet and other packets that may follow and belong to the same session of data traffic. The network assignment control 56 can also tear down (e.g., close) an existing session after it has been completed (e.g., remove the session from a session table). For example, a given session comes into existence when a packet arrives from the site network and is not found in the session table. Sessions can be removed (e.g., closed) either by observing a TCP packet closing a connection that corresponds to an open session. As mentioned previously UDP packets are connectionless and are timed out and removed after a prescribed time interval with no additional packets in the session. If a UDP packet arrives that was previous in a session, which has already timed out, another session can be created.

In some examples, the session network assignment control 56 performs load balancing when assigning sessions of data traffic to respective network connections. The load balancing may be based on capacity of the network connections or other criteria such as disclosed herein. As one example, session network assignment control 56 assigns each new flow of data traffic to a respective (single) network connection, with flow assignments to each network connection being weighted in proportion to the estimated capacity of each network. The estimated capacity for each network connection can be computed by the session network assignment control 56 or it can be set to the static bandwidth configured for the network connection (e.g., configured by user input to match the bandwidth in the service provider service level agreement). In some examples, the session network assignment control 56 assigns new flows of data traffic by a weighted estimated capacity of each network without regard to the number of existing flows or the amount of traffic already on each network. As an alternative example, the session network assignment control 56 assigns new flows of data traffic, with flow assignments weighted in proportion to an estimated remaining capacity of each network. For instance, the remaining capacity of each network is estimated by subtracting average recent measured throughput from the estimated capacity of each respective network. Sessions may or may not be assigned deterministically. If assigned deterministically, new sessions are assigned to the network with the largest estimated remaining capacity. If sessions are assigned non-deterministically, the probability of a session being assigned to a network is proportional to its estimated remaining capacity.

In addition to assigning a given session to a respective network to which it will remain assigned for all subsequent packets in the given session, the network assignment control block 56 can also reassign a session. As disclosed herein, for example, packets in certain sessions can be determined (e.g., by packet prioritization/routing block 58) to be high priority packets. In certain conditions, as defined by a set of rules, network assignment control block 56 can reassign a session to a different network connection 52. For example, when it is has been determined that quality over the currently assigned network cannot be maintained for timely delivery of outbound packets of high-priority time-sensitive sessions, the session network assignment control block 56 can reassign the session to a different available network. For example, the determination to reassign can be based on active and/or passive measurements for the outbound traffic that is provided via each of the respective networks 52. While the priority, which can be determined by the packet prioritization/routing block 58, can be utilized to reassign ongoing sessions based upon the active/passive measurements over the network 52, all sessions over a given network can be reassigned if it is determined that the given network connection is lost of if its capacity drops below a predetermined threshold. Under normal operating conditions where multiple network connections remain available, however, only those packets determined to be high priority packets (e.g., any packet determined to have sufficient priority—other than low priority traffic or traffic having no priority), as disclosed herein, are analyzed for reassignment to another network.

Where multiple available networks exist, the packet prioritization/routing block 58 utilizes the network assignment from session network assignment control block 56 to control to which network (e.g., selected from network 1 through Network N) is to be utilized for sending the packets. The packet prioritization/routing block 58 categorizes each of the packets and determines a corresponding priority for sending each data packets via its assigned network. In order to facilitate the prioritization of the outbound packets over the corresponding networks 52, the link quality manager 50 can instantiate plurality of queues 60 for each of the respective networks 1 through N. For instance, at least a high priority queue and a low priority queue may be instantiated. The low priority queue(s) can receive traffic that is categorized, explicitly or implicitly, as something other than the high priority. As disclosed herein, the packet prioritization/routing block 58 thus can place data packets that are determined to be high priority, time-sensitive data in the high priority queue 60 and other data to one or more available low priority queues.

As mentioned, in some examples, the packet prioritization/routing block 58 and the respective queues 60 can be implemented within the operating system kernel based on user instructions. Additionally or alternatively, functions (e.g., user applications) outside of the kernel can be used to implement some or all functionality of the packet prioritization/routing block 58. For example, a corresponding service can provide a user interface for implementing and configuring for traffic control in the communication system. In response to user instructions via the user interface, the service can establish a set of rules to define data and metadata to categorize and queue the outbound data packets 54 for each network connection. For example, the link quality manager 50 can implement a kernel-level interface to program operating system kernel functions with rules and user-level applications that establish methods for analyzing and categorizing data packets. The packet prioritization/routing block 58 is further programmed to place the data packets in the appropriate queue for each respective network 52 based on the determined categorization.

For the example IP data packets, the packet prioritization/routing 58 can employ rules that evaluate IP headers, and depending upon certain categories of traffic derived from the IP headers, the packet prioritization/routing can evaluate additional information that may be provided in the payload or other parts of the respective packets. For instance, a UDP packet can be evaluated to determine its port number from the header, and the port number used to categorize the packet. As another example, identification of a TCP packet can trigger inspection of the payload to determine that it is web traffic for a predetermined web application (e.g., a customer relationship management (CRM) software service like Salesforce or Microsoft Office365), which is considered time-sensitive, high-priority to users at the site. As yet another example, the packet prioritization/routing block 58 can analyze packet headers to categorize interactive media data packets, such as voice and/or video, as time-sensitive, high-priority traffic and, in turn, place such interactive media data packets into the high priority queue of the assigned network. As a further example, the packet prioritization/routing block 58 examines DNS names and well-known IP addresses, which can be preprogrammed or learned during operation, to help identify the application and, in turn, categorize the packets to determine an appropriate priority of such packets.

As still another example, certain application DNS names or IP addresses can be determined as interactive or time-sensitive traffic as to require prioritization. These names and IP addresses can be programmed in response to a user input and/or be learned in response to application of the prioritization/routing control to other traffic a priori. Regardless, such DNS names and IP addresses can be stored as part of the prioritization rules and utilized as part of the packet prioritization/routing block 58 to facilitate sending traffic with priority to and/or from corresponding locations.

Since priority and non-priority applications may use the same protocols, the packet prioritization/routing block 58 can identify traffic that is sent to or received from well-known domain names. As another example, the packet prioritization/routing block 58 can identify traffic based on its resource location, such as can be specified as a uniform resource indicator, such as a uniform resource locator (URL) and/or uniform resource name (URN). For an example where the egress/ingress traffic to and from the network 52 relates to data traffic for a company or other enterprise, a given online service (e.g., Facebook) uses a variety of applications, such as including messaging, live two-way voice and live video communication. Business video may be high priority, but Facebook videos are considered non-business. So, in this example, systems and methods herein are programmed for watching the traffic to the given online service (e.g., Facebook) to identify whether the UDP video relates to traffic of the given online service or the UDP video is traffic for the company's video conferencing application.

In these and other types of packets, there may be no information in the header indicating whether it is voice or video, especially real-time, interactive video compared to a recording or a one-way broadcast. Accordingly, in many examples, the packet prioritization/routing block 58 evaluates packets to ascertain a behavior of the data traffic for each session, which behavior may vary over time for a given session. This analysis of traffic behavior by the packet prioritization/routing block 58 thus may involve more than evaluating a single packet. That is, the packet prioritization/routing block 58 is programmed with analysis methods to determine the behavior by evaluating a series of multiple packets for a given session, which may or may not be sequential packets, and categorize the packet based on the determined behavior. For example, the packet prioritization/routing block 58 may first see a DNS query, then a port number indicating SIP, and then UDP packets indicating an interactive stream. Together, the DNS request, SIP port number and UDP packets constitutes a behavior for the given session (determined by the packet prioritization/routing block 58) categorizing the session is an interactive, high priority connection and thus should be put in a high priority queue 60.

As a result, to identify a phone call or interactive video, for example, the packet prioritization/routing 58 evaluates the SIP traffic used to set up the call and then do deep packet inspection in order to see the IP address and port number for categorizing such voice or video session. That is, the packet prioritization/routing 58 performs a stateful method of categorization, which is not normally done for IP traffic. However, in some examples, the egress/ingress pair is located near the edge of the network (e.g., last mile or first mile), network connections tend to be lower than at the network core. Consequently, processor computing speeds are sufficient to enable the stateful method of packet categorization at each of the egress and ingress control apparatuses to provide a scalable solution to categorize packets and their respective sessions.

By way of further example, the packet prioritization/routing 58 implements stateful packet inspection (e.g., deep packet inspection—DPI). As disclosed herein, the stateful method of packet inspection is facilitated since a significant portion of it can be performed when the session starts, and if it can be marked as low priority on the 1^{st} packet, then a state for the session can be set at low cost. In other more complicated types of traffic (e.g., a Facebook session that results in UDP traffic) that is to be marked with an associated priority, the packet prioritization/routing 58 implements a method to track such types of traffic (e.g., Facebook sessions) in parallel, which can involve multiple sessions due to the possibility of many protocols for a given type of traffic.

As an example, the packet prioritization/routing 58, operating at the kernel level, signals an event to a categorizer operating outside the kernel (e.g., a user-level application), which can run in the same or another processor. In some cases, a substantial amount of traffic (e.g., a plurality of packets or predetermined information extracted from packets from one or more sessions) can be sent to the user-level categorizer in real time to enable the categorizer to identify a session's priority according to established priority rules. In response to identifying the session's priority, the user-level categorizer notifies the kernel-level packet prioritization/routing to set its priority accordingly. Thus, in some examples, the categorization for a given session can implement a stateful process that is performed as a user-level process operating in parallel with and offloading kernel level functions to identify an application associated with a respective session and mark its priority accordingly. Thus, by offloading the categorization and/or deeper packet inspection from the OS kernel to such user-level application(s), stateful packet inspection is facilitated.

The categorization can be used within the operating system kernel, such as by adding metadata (e.g., marking the packet to specify a categorization or type) associated with each data packet, for placing the data packets from the IP stack into corresponding queues. A network interface identifier can also be added to the data packet as part of the metadata used in the operating system kernel to enable routing of each data packet to its assigned network 52. The metadata can remain with the packet in the queues 60 or it may be stripped off as the packets are placed into the appropriate queues. The packet prioritization/routing block 58 thus places the packets in the appropriate priority queue associated with the network to which the session has been assigned based on the prioritization of each respective session, which prioritization may be set by user-level functions, kernel level functions or a combination thereof.

As one example, the information in the queues 60 includes pointers to address locations in the IP stack to enable the network 52 to employ its drivers to access the queued outbound packets from the IP stack according to the prioritization queue into which each packet has been placed. In this way, the marking and categorization of each of the packets, will result in being placed in a respective queue is not implemented in the IP stack itself but only within the operating system kernel to facilitate and enable the network to retrieve packet in the appropriate priority. Thus the network assignment control 56 can specify which network interface a given packet is to be provided based upon its session assignment information. The packet prioritization/routing block 58 can in turn place the packet in the appropriate queue for the identified network interface according to the categorization implemented by the packet prioritization/routing block.

As mentioned the corresponding link quality manager 50 is implemented in each of the egress control apparatus 12 and ingress control apparatus 14 such that the categorization, prioritization and routing of packets occurs in both egress/ingress directions in respective to the site. A network driver or other interface for each network 52 can retrieve data packets from its high-priority queue before packets from any lower priority queue. As a result, lower priority traffic is sent later and, depending on overall network capacity may be dropped. The packets can be sent out via the network 52 to the other ingress or egress control apparatus to transmit at the measured capacity for egress or ingress of data traffic, as disclosed herein.

FIG. 3 depicts an example of session network assignment control 56 such as disclosed with respect to FIG. 2. Thus, the session network assignment control 56 can be implemented within the egress control apparatus 12 as well as the ingress control apparatus 14. As disclosed herein, the session network assignment control 56 implements initial session assignment and subsequent reassignment of sessions to available networks. As mentioned, the functionality of the session network assignment control 56 can be implemented in the operating system kernel space.

The session network assignment control 56 includes a packet evaluator 70 to inspect predetermined information in respective data packets to determine which existing session the packet belongs or that the packet corresponds to a new session. For example, the packet evaluator 70 can define each session from IP header data as a session tuple, including a source IP address, a source port, a destination IP address, a destination port, a DNS request (e.g., DNS query), and a network protocol. The session network assignment control 56 can utilize the packet information (e.g., the session tuple) to determine if the outbound packet matches an existing session. For example, the packet evaluator 70 can compare the session tuple for each outbound data packet with stored session data 72 to determine whether or not an existing session exists for each respective outbound packet. If no session exists, a session generator 74 can generate a new session based upon the determined session information mentioned above. The session generator 74 can store the session tuple for each new session in the session data 72. For example, the session generator 74 can store the session data 72 in a data structure, such as a table, a list or the like, to indicate a current state for each existing session. A session terminator 75 can be provided to close an open the session. For example, in response to terminating a session, such as in response to a command to close a session or the session timing out, the session terminator can remove session information or otherwise modify the session table to indicate the session is no longer open.

As disclosed herein, each of the outbound packets are assigned to a respective network connection (e.g., communication link) that is determined for each session. The assigned network can be stored in network assignment data 76. In some examples, the network assignment data 76 can be stored as part of the session table in the session data 72. In other examples, the network assignment information for a given session can be stored separately. For instance, the session information operates as an index to look up the network assignment for each session. To control network assignment for each session, the control 56 can include a session link assignment function 78.

The session link assignment function 78 includes an initial assignment block 79 programmed to control initial session assignment and a session reassignment block 81 to control reassignment of each respective session that has already been opened. The initial assignment block 79 can implement various functions and methods according to the particular networks that might exist as well as the number of networks available for sending outbound traffic. As one example, the initial assignment block 79 employs a simple round-robin algorithm to arbitrarily assign each session to a respective network in an arbitrary order. Each session can be assigned in a listed order of available networks and upon reaching the end of the list the session link assignment can begin again at the beginning.

In other examples, the assignment functions 79, 81 can employ different selection assignment algorithm for sessions that have been categorized as high-priority sessions (e.g., high-priority, time-sensitive traffic) compared to lower priority sessions or sessions having no priority. For example, if the initial assignment function 79 is assigning a priority session, the assignment function can evaluate a plurality of available links for a suitable link, such as a given link that has the best track record or current score meeting the required quality level for this session category. The categorization of the session can be determined dynamically for each packet (e.g., by packet evaluator 70) or for an existing session, defined by session data 72 (e.g., as determined by packet evaluator 70). To implement such selective assignment for different session categories (or determined traffic behavior), the initial assignment function 79 thus can utilize session network analysis 80 to ascertain network characteristics and utilize its characteristics in the assignment of each session. For the example of UDP media sessions, network analysis can determine a quality metric based on measurements of latency, jitter, and/or loss of data packets. For the example of a TCP session, quality can be measured by observing session latency, throughput and/or packet re-transmissions from one end of the session.

The network analysis 80 can also include a load evaluator 84 to evaluate and determine indication of network load (aggregate throughput of data traffic) that is being sent over each available network. The network analysis 80 can utilize the determined capacity and load throughput of each respective network to statically or dynamically estimate network capacity for each network. The estimated network capacity can be utilized by the initial assignment function 79 of the session link assignment 78 to assign a given media session to a corresponding network for load balancing purposes. As one example, each new session is assigned to an available network with a larger capacity (e.g., a capacity meeting a threshold capacity for the respective session category being assigned).

By way of further example, the initial assignment function 79 can assign new sessions to networks based on a static performance ratio of each network. For instance, each service provider oftentimes specifies a maximum bandwidth for a given user's connection. This may be specified in a contract (service level agreement) or published online or elsewhere. The maximum available bandwidth thus can be provided as input data specifying a static capacity to capacity calculator 82 of network analysis 80, to compute a corresponding static ratio of relative performance for each of the available network connections. The network analysis 80 can compute respective static performance ratios for each network according to its fractional part of the aggregate bandwidth. As an example, assume that network A has 10 Mbps rated performance and network B has 3 Mbps rated performance. In this case, that session link assignment 78 would choose network A 10/13ths of the time and network B 3/13ths of the time for new session assignments. Such static ratios can be computed and utilized for session assignments in each of the ingress and egress control apparatuses for sending traffic for the given session.

As another example, the capacity calculator 82 can determine a dynamic capacity estimate for each of the network connections. The dynamic capacity estimate provides an indication of available capacity for each network determined from dynamic measurements of the network instead of a static bandwidth specified for the network. For instance, the capacity calculator is programmed to compute an estimate of capacity based on the maximum throughput measured over a given network. This maximum throughput may be computed over the entire history of measurements of a given network, measurements over a specific period of time such as a most recent period, measurements since a specific event such as a change in network configuration specified by user input or detected by capacity calculator 82, or a combination of these methods. The initial assignment function 79 can assign new sessions to networks based on a performance ratio using a dynamic capacity estimate for each network, a static capacity specified for each network as mentioned above, or a combination of the static and dynamic capacity estimates. For example, when a dynamic capacity estimate is not known or cannot yet be determined (e.g., because insufficient measurements are available), a static capacity can be used. Alternatively, a dynamic capacity estimate can be determined (by capacity calculator 82) based on the maximum throughput measured with good quality. As an example, the capacity calculator 82 obtains a measure of downstream (i.e. ingress) throughput (from load evaluator 84) and quality (the determined quality metric), and then estimates capacity as the throughput at or near the boundary between good and bad quality (the quality boundary).

As yet another example, a sum or linear combination of downstream and upstream capacity estimates can be used, including downstream capacity determined dynamically or statically and upstream capacity determined dynamically or statically. Using a sum of upstream and downstream capacity estimates may balance load appropriately in some cases, for example across a symmetric WAN (e.g., 50 Mbps down, 50 Mbps up) and an asymmetric WAN (e.g., 50 Mbps down, 5 Mbps up). In situations where a simple sum results in upstream being taken into account too much (or not enough), the capacity calculator 82 can compute capacity as a linear combination of downstream and upstream, such as downstream*⅔+upstream*⅓, which weights downstream more than upstream. Each of these combinations of downstream and upstream capacity estimates (sum and linear combination) can work for both total capacity estimates and remaining capacity estimates. For remaining capacity estimates, a simple sum just adds remaining downstream capacity to remaining upstream capacity. A linear combination of upstream and downstream capacity can similarly be determined for remaining capacity.

In some examples, the session assignment and reassignment functions 79 and 81 may implement load balancing based on the capacity, as disclosed herein. For example, the network analysis 80 can include the capacity calculator 82 to compute an estimation of the capacity (e.g., in terms of bandwidth, such as bytes per second, or a normalized index value) for each respective network. As mentioned, the estimated capacity may be provided to indicate the current total capacity and/or a remaining capacity for each respective network, and further may include upstream and/or downstream capacity estimates. For example, capacity calculator 82 can compute a performance ratio for each network based on the remaining capacity of the network as a fractional part of the aggregate capacity remaining for all such networks in connections 18. The remaining capacity of each network can be computed by measuring average throughput of data transmitted and/or received over a recent time period and subtracting this average throughput from a dynamic capacity estimate or a static capacity specified for the network. In some examples, the capacity calculator 82 is configured to compute the estimated capacity as an upstream (i.e. egress) static bandwidth or, if enabled (e.g., in response to a user input or other setting), an upstream dynamic bandwidth. For instance, the load evaluator 84 is programmed to measure aggregate upstream bandwidth for each network connection based on outgoing traffic for such connection. Additionally or alternatively, the capacity calculator 82 is configured to compute the estimated capacity based on a downstream (i.e. ingress) bandwidth. For instance, the capacity calculator 82 determines the downstream bandwidth, corresponding to capacity for a given network, based on the load evaluator 84 measuring downstream throughput.

In some examples, each of the assignment functions 79, 81 is programmed to utilize the load evaluator 84 as part of a session assignment algorithm to implement load balancing when assigning sessions to the network connections (corresponding to WANs). As one example, the assignment functions 79, 81 assign a given session to a given one of the plurality of network connections weighted by estimated capacity, such as determined by capacity calculator 82. As another example, in situations when capacity estimates are unavailable (or are known to be inaccurate) for one or more of the network connections, the assignment functions 79, 81 are programmed to assign more weight to WANs with unknown capacity (than those having a known, estimated capacity). Weighting in this manner enables the assignment functions 79, 81 to put more traffic into the connections to use for estimating capacity. As mentioned, the capacity weighting that is performed by assignment functions 79, 81 may be based on the estimated current aggregate capacity for a given connection or estimated remaining capacity for the given connection.

Additionally or alternatively, the assignment functions 79, 81 may apply the weighting deterministically or non-deterministically when assigning new sessions (data traffic flows) to the available network connections. For example, if an assignment function 79, 81 is configured (e.g., in response to user configuration or other setting) to assign sessions deterministically, new sessions are assigned to the network that is determined to have the largest estimated capacity or remaining capacity (determined by capacity calculator 82). If an assignment function 79, 81 is configured to assign sessions non-deterministically, the probability of a flow being assigned to a network is proportional to its estimated capacity or remaining capacity. It is to be understood that, in some examples, since the estimated capacity is the estimated capacity with good quality metric (e.g., binary or other quality metric), quality is already included in the capacity estimate and does not need to be accounted for separately when assigning new flows.

The network analysis function 80 can also include a failure detector 86 to detect whether one or more networks has experienced a failure, which may be temporary or permanent. If the failure detector 86 detects that a given network has failed, it can be marked as down such that the initial assignment function 79 assigns no new sessions to the down network. The computations used by the network analysis 80, such as capacity and load calculators mentioned above, can also be adjusted to reflect such down network. As an example, the failure detector 86 can ascertain if a network is down by periodically sending a ping request to a well-known host (e.g., google.com or other service) via each network connection. If there is no response when the request is sent over a given network, the given network can be marked as down. This can be repeated by the failure detector 86 at a desired testing interval or at another programmable time period. Once the testing is successful, the status of the given network can be changed from down back to an operational status. The network status thus can be used to enable the link quality manager of the respective ingress or egress control apparatus to send outbound traffic via the given network that has been assigned for each session.

In addition to the initial or original assignment of a session to a given network (e.g., implemented by initial assignment function 79), the session reassignment block 81 is programmed to reassign a session from a currently assigned network to another network based upon the network analysis function 80 applied with respect to an open session. Since a communication system implementing the bi-directional traffic control disclosed herein includes an apparatus at the site as well as in the cloud (e.g., a last mile connection or other remote location), systems and methods disclosed herein have the ability to determine and understand a measure of network performance in both directions for each session. Thus, the network analysis function 80 may cooperate with information that is received from the remote apparatus (including coordination of bandwidth measurements). For instance, the network analysis function 80 can monitor traffic that is sent out from its location via a given network, as mentioned with the respect to the initial session assignment. The network analysis 80 can perform passive measurements, active measurements or a combination of passive and active measurements for each of the available networks. As used herein, active measurements involve creating additional traffic that is sent in the outbound traffic via one or more of the networks for the purpose of making such measurements, whereas passive measurements evaluate measurements made on existing traffic being sent out of one of the egress or ingress control apparatus that is implementing the session network assignment control block 56. Examples of some types of measurements that can be utilized by the network analysis function 80 to determine whether network link connection reassignment is necessary for high priority or time-sensitive data sessions can include network failure, local path sojourn time and jitter. In one example, the network analysis 80 can perform an active measurement of network capacity by sending test data of a predetermined size (e.g., one MB) to its associated control apparatus and determine the travel time for the test data to arrive. The travel time can be divided by the size of the test data to determine capacity. In some examples, the measured capacity is a current capacity, such as may be continually updated in a dynamic manner over time. For instance, timely capacity measurements may be performed for each network connection at a rate that is at least twice as fast as the network can change. In other examples, the capacity may be measured for each network connection at slower rates (periodically or intermittently). The capacity measurement rate may be programmable to a value (e.g., milliseconds, microseconds) as to set the rate at which capacity is determined for one or more network connections for egress of data packets with respect to one or both apparatuses 12, 14.

By way of further example, the failure detector (or another function) 86 can be programmed to send a ping from its egress or ingress control apparatus to a predetermined recipient. For instance, the predetermined recipient for egress or ingress control apparatus can be the associated ingress or egress control apparatus. The ping can be a simple request for an acknowledgement response, for example, that the sender uses to ascertain whether or not a given network connection is up or down. Where a given egress or ingress control apparatus includes multiple connections, the ping can be provided via each connection periodically. As one example, to ensure connections are maintained for interactive and/or real-time media traffic, such as voice and/or video conferencing, the ping can be sent via each network connection at an interval. The ping interval can be set to a default level or be user programmable to a desired time (e.g., about every 300 milliseconds, every second or at another interval). Since the ping requires a response from a recipient (e.g., ingress or egress control apparatus), it corresponds to an example of an active measurement.

As another example, the session network assignment control 56 can include a path sojourn time calculator 88 to measure queue sojourn time. The queue sojourn time is an example of a passive measurement that can be used for session reassignment. The path sojourn time calculator 88 can measure the time that it takes for a given outbound packet to travel along the path (or at least a portion of the path) through the link quality manager (e.g., link quality manager 50) to the network (e.g., network 52). As one example, the path sojourn time calculator 88 can include a clock and determine the sojourn time measurement as the difference in clock values from when a given packet is input into a respective queue until when the given packet is output from the respective queue. In some examples, the path sojourn time calculator 88 can measure the sojourn time with respect to packets that pass through the high-priority queue for each network. In other examples, the path sojourn time calculator 88 can measure the sojourn time with respect to packets that pass through the lower priority queues. The network analysis function 80 can be programmed to determine the quality of the media traffic being measured from the measured sojourn times for data traffic sent through the respective queues.

For example, the network analysis function 80 can compare the sojourn time with respect to one or more thresholds. The sojourn time threshold can be set as a function of the bandwidth of the particular network link that the queue is coupled to output data packets. So long as the network analysis function 80 determines that the sojourn time is sufficiently short (e.g., less than a predetermined threshold), then it indicates that the high-priority traffic may have good quality. That is, short sojourn time means a time that is somewhat longer than packet transmission time. A sojourn time threshold can be set based on expected link speeds, which can be determined by the capacity calculator 82. For instance, when congestion occurs in the path between the ingress/egress apparatus, the rate at which packets are sent out via a given network will slow down, resulting in a corresponding increase in sojourn time. Thus, the network analysis 80 can monitor the progress of data packets through the queues and determine whether to increase or decrease the load for each network link.

Traffic may be bursty (e.g., exhibiting intermittent times of increased data traffic), so sojourn time may need to be measured for multiple packets over a several second time period (e.g., a moving measurement time window). In this example, an outlier time of about 200 ms during the measurement time window exceeds a 100 ms threshold, and thus can indicate poor quality to trigger the session link assignment function 78 to reassign the session to another network link. To mitigate the frequency of session reassignment, the session link assignment function 78 can be programmed to require multiple outliers during a prescribed time period. For instance, the session link assignment function 78 can be programmed to reassign a given session if Q packets (e.g., where Q is a positive integer) exceed the sojourn time threshold during a prescribed time period (e.g., about 1 second).

As another example, the session network assignment control 56 can include a jitter calculator 90 to quantify jitter for each of the plurality of network connections. The jitter calculator can measure far end jitter and/or near end jitter. Jitter refers to a variation in the delay of received packets, such as can be determined when a sender (e.g., the source that that sends media data from one of the egress or ingress control apparatus) transmits a steady stream of packets to the recipient (e.g., the other of the ingress or egress control apparatus). The jitter calculator 90 can calculate jitter continuously as each data packet is received from its source via one of the network connections.

For example, the jitter calculator 90 can compute jitter as an average of the deviation from the network mean packet latency. As a further example, the jitter calculation performed by jitter calculator 90 can be implemented according to the approach disclosed in real time control protocol (RTCP). For instance, jitter calculator 90 can compute an inter-arrival jitter (at the recipient apparatus) to be the mean deviation (e.g., smoothed absolute value) of the difference in packet spacing at the receiver compared to the sender for a pair of packets. Other forms of jitter calculations may be used. An active jitter measurements can be implemented by having the far end (e.g., recipient) compute jitter for each packet in a high-priority, time critical session. The recipient can transmit an indication of the computed jitter back to the sender. Alternatively, the timing data used to determine jitter itself can be sent back to the sender, which can be programmed compute the corresponding jitter. In other examples, the packet sent from the egress control apparatus can be sent to the ingress control apparatus and returned to the egress apparatus to compute an indication of jitter.

In response to determining back at the sender that the computed far end jitter for a given session exceeds a predetermined jitter threshold, the session link assignment function 78 can reassign the given session to another network link. Additionally, for the example of RTP encoded data, the RTP packets have a sequence number. In response to one or more packets in the sequence omitted from the received media, the recipient control apparatus can determine if there are missing packets and return a count indicating the number of missed packets as well to the sender, which can be used by network analysis function 80 to trigger reassignment if the number of dropped packets within a time interval exceeds a threshold number.

The computed jitter can provide both a quality measure and a network down indicator. If no jitter measurement packets are received via a given network, for example, the failure detector 86 can determine that the given network is down. When a network link is determined to be down (e.g., by failure detector 86), all sessions currently assigned to such link (e.g., as stored in network assignment data 76) are reassigned to one of the available networks according to session assignment methods disclosed herein.

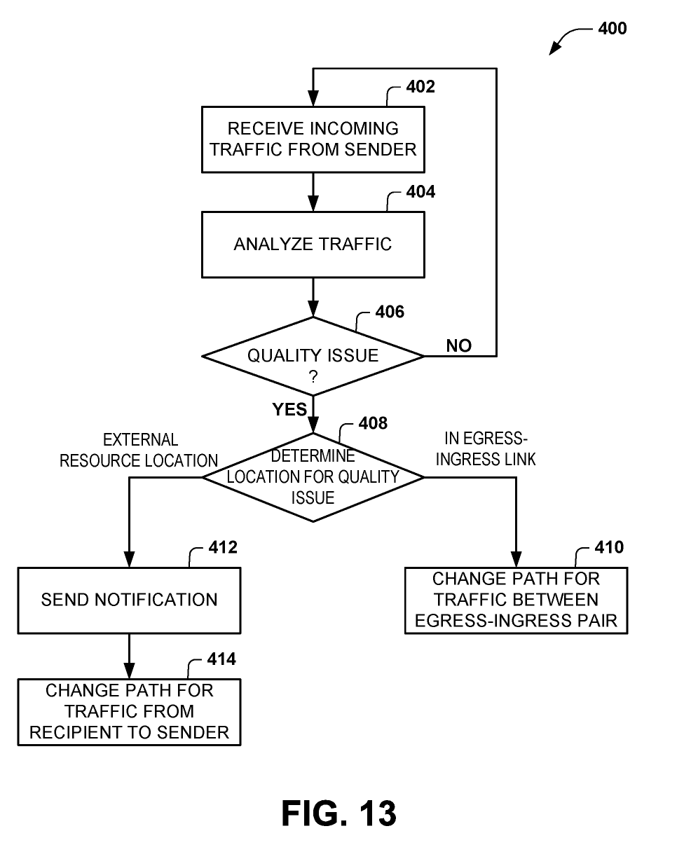

Additionally or alternatively, the jitter calculator 90 at a given egress or ingress control apparatus can compute near end jitter on arriving traffic for a given session via each of the network connections. Similar computations at the recipient of the media traffic that is sent to recipient can thus be performed to compute the near end jitter. The network analysis can employ the near end jitter that is computed locally to determine whether jitter for a given network connection exceeds a prescribed threshold or is down. In response, the session link assignment function 78 can reassign the session to a different available network for use in communicating media traffic for such session between ingress and egress control apparatuses. In situations where the properties analyzed by the network analysis 80 (e.g., capacity, load, failure, loss and/or jitter) relate to traffic received via link that is not between the egress apparatus and ingress apparatus, additional network analysis can be performed to localize the problem associated with the network traffic, such as disclosed herein (see, e.g., FIG. 13). Thus a notification can be sent to administrators within and/or external to the site to help triage the problems so that appropriate action can be taken to mitigate the issue.

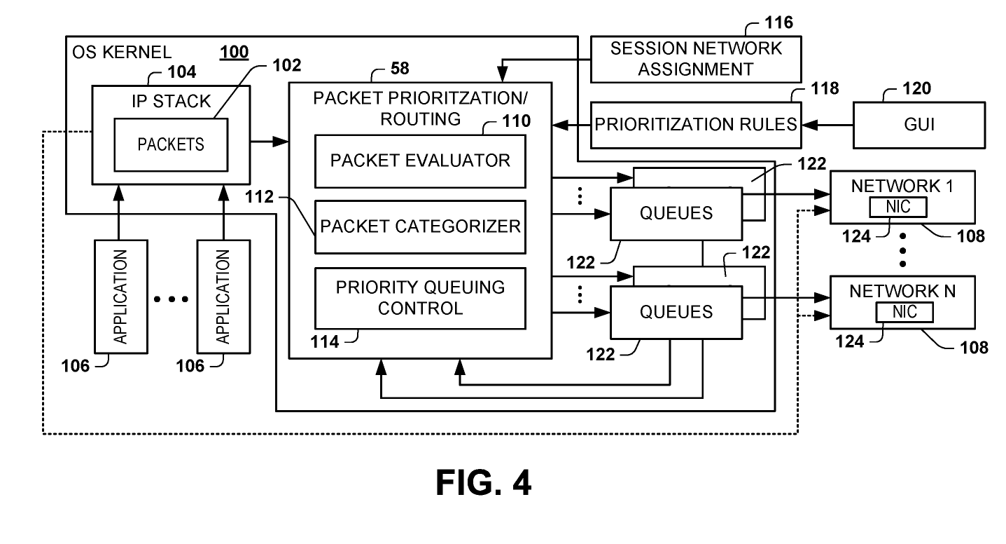

In the example of FIG. 4, the OS kernel 100 implements the packet prioritization/routing function 58 to control prioritizing of outbound data packets 102 that reside in the IP stack 104. For example, the packets in the IP stack 104 are provided from local applications 106 that provide outbound data traffic to one or more remote endpoints (e.g., remote applications executing on respective processing devices). For example, the application 106 can be executed within a site where the packet prioritization/routing function 58 is implemented in the egress control apparatus or the application 106 can be implemented in another computing device remote from the site where the corresponding packet is received over a corresponding network, such as a wide area network (e.g., the internet). An input interface (not shown) can provide the outbound packets from the stack to the OS kernel 100 for processing by the packet prioritization/routing function 58. The packets 102 in the IP stack 104 thus are outbound packets to be sent via a corresponding network connection 108 and according to the prioritization of the packets implemented by the packet prioritization/routing function 58.

The packet prioritization/routing function 58 includes a packet evaluator 110, a packet categorizer 112 and a priority queuing control 114. Each of the prioritization/routing functions 110, 112, and 114 can be implemented as kernel level executable instructions in the OS kernel 100 to enable real-time processing and prioritization of the packets 102. In other examples, the prioritization/routing functions 110, 112, and 114 can be distributed within the operating system kernel and user application space or entirely within user application space (outside of the operating system). The packet prioritization/routing function 58 also utilizes session network assignment data 116 such as can be determined by the session network assignment control 56 (FIG. 3). As mentioned, the session network assignment control 56 can specify a network interface for each session to which each one of the packets 102 will be sent. For example, the packet evaluator 110 evaluates each outbound packet 102 relative to the session network assignment data 116 to ascertain whether the outbound packet belongs to an existing session. If a packet does not belong to an existing session, a new session will be created and that session will be assigned to a given network interface, such as described with respect to FIG. 3. If only a single network interface exists (e.g., N=1), each session is assigned to the common network interface.

The packet evaluator 110 executes instructions (e.g., kernel level packet inspection) to evaluate certain packet information for each packet 102 in the stack 104, which information may be different for different types of packets and depending on the prioritization rules 118. The packet categorizer 112 uses the packet information from the packet evaluator 110 to categorize the packet according to the type of traffic to which the packet belongs. The packet evaluator 110 can evaluate IP headers for each of the outbound packets upon receipt via the corresponding input interface. As one example, the packet evaluator 110 can evaluate IP headers in the packet 102 to determine the protocol (e.g., TCP or UDP), and the determined type of protocol further can be utilized by the packet evaluator to trigger further packet evaluation (e.g., deeper inspection) by the packet evaluator that is specific for the determined type of protocol. For instance, in response to detecting a UDP packet, the packet evaluator 110 can further inspect contents of the packet to identify the port number, and the packet categorizer 112 can categorize the UDP with a particular packet categorization based upon its identified port number. In other examples, the packet categorizer can determine a category or classification to be utilized for a UDP packet based upon evaluation of the packet's DSCP value.

As yet another example, the packet evaluator 110 is programmed to evaluate each data packet to determine a behavior of the data traffic based on the session tuple, such as can include two or more of a source IP address, a source port, a destination IP address, a destination port, a DNS request (e.g., DNS query), a network protocol and a differentiated services code. The packet categorizer 112 thus can classify each packet based on the session tuple determined by the packet evaluator 110 for each respective packet.

As another example, in response to the packet evaluator 110 detecting the outbound packet is TCP data, the packet evaluator 110 can look at the payload to determine if it is web traffic and, if so, which particular application may have sent it or to which application it is being sent. For example, certain applications can be specified as high priority data in the corresponding prioritization rules 118. As mentioned, for example, the prioritization rules 118 can be programmed in response to a user input entered via a graphical user interface 120 (e.g., implemented as part of a control service). The prioritization rules 118 thus can be programmed in response to the user input, which rules can be translated to corresponding kernel level instructions executed by the packet prioritization/routing function 58 to control prioritize routing of each of the outbound packets. Based on the evaluation of each data packet, the packet categorizer 112 determines corresponding categorizations that are be assigned to each of the packets to enable prioritized routing.

By way of example, the packet categorizer 112 tags (marks) each of the packets, such as by adding priority metadata to each packet, specifying the categorization (priority class) for each respective packet based on the evaluation performed by packet evaluator 110. The priority queuing control 114 thus can employ the priority metadata, describing one or more categorizations of the packet, to control into which of the plurality of queues 122 the outbound packet is placed to be sent over its assigned corresponding network. As an example, within the OS kernel 100, each data packet can be processed as kernel data consisting of pointers to actual packet data that may reside outside the kernel. The packet categorizer 112 can add kernel-level header information to the kernel data (pointer), corresponding to the metadata describing the classification of the respective data packet to enable further kernel processing.

As a further example, the priority queuing control 114 is programmed to make a decision about whether to classify a given session of data traffic as high or low priority (or any number of different priorities that are being used). For example, the priority queuing control 114 makes the decision on priority based on the prioritization rules 118, which may be established based on data that has been gathered over time. As an example, the data gathered may include existing and recent streams from the source device, recent DNS queries emanating from the source device or network, and MAC address information. In some examples, the packet prioritization/routing block 58 or another service monitors DNS queries and caches (in memory) a mapping of IP address to possible DNS names. This allows the service to identify particular services from IP addresses.

As a further example, the packet categorizer 112 of packet prioritization/routing block 58 can employ the rules 118 to classify data traffic according to the behavior of such traffic that is determined by the packet evaluator 110 analyzing a predetermined session tuple for series of packets belonging to a given network session. Examples of some rules 118 that might be defined and utilized by the packet prioritization/routing 58 to classify traffic are as follows:
Source MAC address starts with 00:01:49. This might classify a particular manufacturer of IP phones. This works if the packet evaluator has access to Layer 2 for the device.
Source device has TCP session with port 5061 of *.myserviceprovider.com, and begins sending UDP packets. This might classify a SIP device using the “myserviceprovider” service.
Source device has TCP session with port 443 of *.acme.com, and begins sending UDP packets. This might classify a WebRTC session with the “acme” service.

As an example, assuming there are a plurality of networks (e.g., N greater than or equal to 2), the network interface 124 associated with each of the network connections 108 thus can be fed data packets from a plurality of queues 122, including one high priority queue and one or more lower other priority queues. The particular network to which the outbound packet is ultimately placed is determined based upon the session network assignment data 116 (e.g., determined by packet evaluator 110). For instance, the session network assignment data 116 can specify a network interface card (NIC) or other network ID used by packet routing/prioritization block to route the data packet to the specified network. The network identifier can be added as part of the packet metadata to the packet information based on the packet evaluator 110 and used by the packet prioritization/routing function 58 to control the routing. Alternatively, each session identifier (e.g., session multi-tuple) can map directly to a network interface, which can be used by the packet prioritization/routing to route each packet to a selected network without adding metadata.

While the packet inspection and processing can be implemented in the OS kernel-level functions 110, as mentioned above, in other examples, such processing can be passed via an API to a user-level application (e.g., one of the applications 106 or another application—not shown), offloading the OS kernel, to categorize and/or determine a priority for the session. The user-level application may be within the same processor as executing the OS kernel. In other examples, the application may be executed by a different processor including residing within the network interface 124 or virtualized in another device (e.g., in a computing cloud).

In some cases, the queuing control can be implemented to address quality issues that can be determined in addition to or as an alternative to quality measures computed for an established session. For example, packet prioritization/routing 58 can examine latency, jitter, and loss on the packets arriving from the IP Stack 104, such as to enable packet prioritization/routing to identify and address quality issues before (or separately from) inspecting a given packet that is assigned to a given session. For the example of an egress apparatus, the quality issue may pertain to within an enterprise site or site device. For the example of an ingress apparatus, the issue can relate to traffic flow in a WAN backbone or within a cloud data center. Thus, the measurements and evaluation of quality for each of the network connections 108 and corrective action, such as reassigning sessions to different links, can extend beyond (e.g., be broader than) the quality of traffic flowing between an established pair of egress and ingress control apparatuses (i.e., an egress/ingress pair).

The packet categorizer 112 employs the prioritization rules 118, which are programmed in response to user input or default rules may be used, to categorize the type of traffic for each outbound data packet. For example, the packet categorizer 112 can add kernel-level metadata that specifies the type of traffic based on the packet evaluator 110. The priority queuing control 114 operates to send the outbound data packet to the appropriate one of the queues 122 for the network interface 124 that has been specified in response to the network assignment data 116. For instance, queuing control 114 can utilize the classification header (e.g., kernel level metadata) for each network to place the packet data in the queue having the appropriate priority according to the categorization associated with each data packet. The network driver accesses the outbound data packet from the high priority queue for sending over its assigned network 108, and then sends lower priority data from the one or more lower priority queues over its assigned network. Since all outbound packets for a given session are sent over the same network connection out of order packets can be mitigated.

The set of priority queues 122 associated with each respective network interface 124 can establish the same or different priority for queuing the outbound packets to each respective network connection. As disclosed herein, the categorization that specifies the type of packet can include any information utilized by the queuing control 114 sufficient to ascertain into which of the plurality of queues 122 the outbound packet is queued for sending over its corresponding network. In some examples, the packet prioritization/routing function 58 can place the data packet from the IP stack 104 into its respective queues 128 as prioritized based upon the categorization and session determined for each respective packet.

In other examples, each of the queues 122 can be populated with pointers (e.g., to physical memory address) to the data packet within the IP stack 104 to enable each NIC 124 to retrieve and sent out each of the respective data packets from the IP stack based on the pointers stored into the queues identifying the priority of the outbound data packets. For example, the pointers can identify the headers, payload and other portions of each respective data packet to enable appropriate processing of each data packet by the NIC 124 of each respective data packet. As a further example, each NIC 124 can also employ corresponding network drivers to retrieve the data from the respective queues and to send the outbound packets over the corresponding network connections 108. The drivers can further be configured to first send out all data packets from the high priority queue prior to accessing data packets that are in the one or more lower priority queues. In this way time-sensitive high priority packets will be sent over each network before low priority data packets are sent over each network.

In some examples, the categorization for certain high priority data packets can be inserted into the data packet itself (e.g., as metadata) to enable downstream analysis of network quality and/or capacity for a respective network connection. For example, since high priority packets may be moved from one network to another network in response to detecting insufficient capacity or performance, outbound high priority data packets can be tagged or marked to enable their identification as high-priority packets at the receiving egress or ingress control apparatus to which the packets are sent via each network connection 108. Such tagging or marking can enable further analysis thereof by a corresponding network analysis function (network analysis 80 of FIG. 3). In this way, the network connection for high priority data packets can be managed dynamically to help improve and maintain quality of service for time-sensitive network traffic that is transmitted between each egress/ingress pair (e.g., between control apparatuses 12 and 14 associated with a respective site). As disclosed herein, examples of high priority packets can include interactive voice, interactive video applications or other data traffic deemed by a user to be time-sensitive compared to other data traffic.

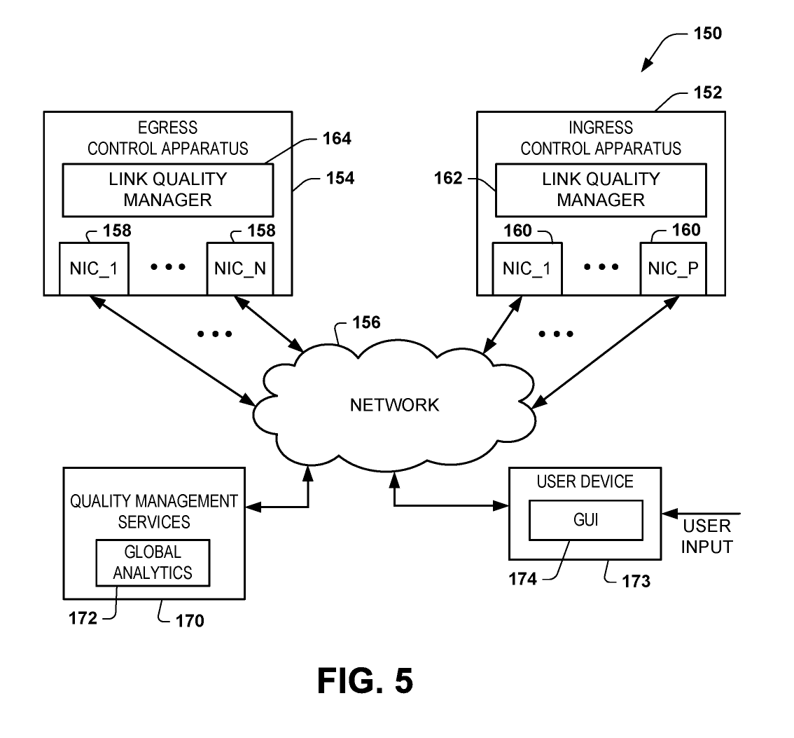

FIG. 5 depicts an example of another communication system 150 that include an ingress control apparatus 152 and an egress control apparatus 154 associated with a given site. As mentioned, the given site may be an office, home, business that supports one or more users or an individual user. In this example, each of the ingress/egress control apparatus 152 and 154 are connected to each other via a corresponding network 156. The network 156 can correspond to a WAN, such as the public internet or other WAN that is at least partially outside control of the site. In the example of FIG. 5, the egress control apparatus 154 is located at a site having a plurality of network connections via corresponding network interface cards demonstrated as NIC_1 through NIC_N, where N is a positive integer greater than or equal to 2. The ingress control apparatus 152 controls ingress of data packets to the site and is connected to the egress control apparatus via a corresponding network interface cards demonstrated at NIC_1 through NIC_P, where P is a positive integer greater than or equal to 2. In some examples N and P are the same or N and P may be different such that each of the ingress and egress control apparatuses may have the same or different number of network connections. Additionally or alternatively each of the NICs can communicate via the same or different types of physical layers or they may be different depending upon the available network connections for each apparatus 152 and 154. In some of the following examples, the NICs 158 implemented at the egress control apparatus 154 may be referred to as site NICs and the NICs 160 implemented at the ingress control apparatus 152 may be referred to as cloud NICs.

Regardless of the implementation of the NIC 158 or 160, each of the egress NICs 158 are logically connected (e.g., via a corresponding IP address) with the ingress control apparatus 152 via the one or more ingress NICs 160. Similarly, for outbound traffic from the ingress control apparatus 152 to the site, each of the NICs 160 are communicatively coupled to the egress apparatus via one more of the NICs 158. The ingress apparatus 152 includes a link quality manager 162 and the egress control apparatus 154 also includes a link quality manager 164, each of which operates to control packet prioritization/routing of outbound traffic as disclosed herein.

The transmission of outbound packets from each of the ingress and egress control apparatuses 152, 154 can be facilitated between the apparatuses by creating communication tunnels through the network 156. For example, tunneling can be established from the egress control apparatus 154 via each of the P networks to the ingress control apparatus 152. Similarly, a tunnel can be established from the ingress control apparatus 152 via each of the P networks to the egress control apparatus 154. That is, the ingress and egress control apparatuses 152 and 154 operate as endpoints for each respective tunnels. As a further example, OS kernel code (e.g., corresponding to packet prioritization/routing and/or session network assignment control) can consider that each tunnel a respective interface 158, 160 via which packets for a given session can be communicated. Thus, the link quality managers 162, 164 can evaluate and mark packets within the operating system kernel to specify the type of the data traffic and a respective network interface. As a result, the categorization and prioritized routing can be performed efficiently based on the marking (e.g., kernel level metadata) at each of the respective apparatuses 152 and 154. As mentioned, in some examples, the processing of the data packets to determine categorization and/or priority thereof can be executed by a user-level application operating in parallel with and offloading the operating system kernel.

As an example, the OpenVPN protocol acts as a wrapper to encapsulate a communications channel using various other network protocols (e.g., OpenVPN uses TCP or UDP) for communicating data packets between ingress and egress control apparatuses 152, 154. The tunnel thus provides a virtual point-to-point link layer connection between ingress and egress control apparatuses 152, 154. In some examples, the tunnels can be implemented as secure (e.g., OpenVPN and IPsec) tunneling to provide for encrypted communication of the data packets between endpoints. In other examples, the tunnels can communicate data without encryption and, in some examples, the applications communicating can implement encryption for the packets that are communicated via the tunnels. As yet another example, encryption can be selectively activated and deactivated across respective tunnels in response to a user input. In either case, the performance of the traffic communicated via the tunnel depends on the network link(s) between tunnel endpoints.

By way of further example, a tunnel can be created for outbound traffic from each of the sites' NICs158 (1-N) to a corresponding one of the ingress NICs 160 (1-P). Similarly, for outbound traffic from the ingress control apparatuses 152 each NIC can be communicatively coupled via the network 156 through a tunnel created from each respective NIC 160 to a corresponding NIC 158. As mentioned, since N and P are not necessarily the same, it is possible that outbound traffic from multiple NICs at one of the site or cloud can be received at an endpoint corresponding to a common NIC at the other cloud or site. Additionally, each path through the network 156 remains under control of one or more service providers that implement the network 156, which further can involve network peering (e.g., at peering points) to enable inter-network routing among such service providers. From the perspective of each ingress and egress control apparatus 152, 154, however, a logical tunnel is established for each network connection to facilitate the transport of the outbound data packets. Thus, other than using a given NIC for sending/receiving data packets, the actual data path for packets through the network 156 is outside of the control of each ingress and egress control apparatus 152, 154.

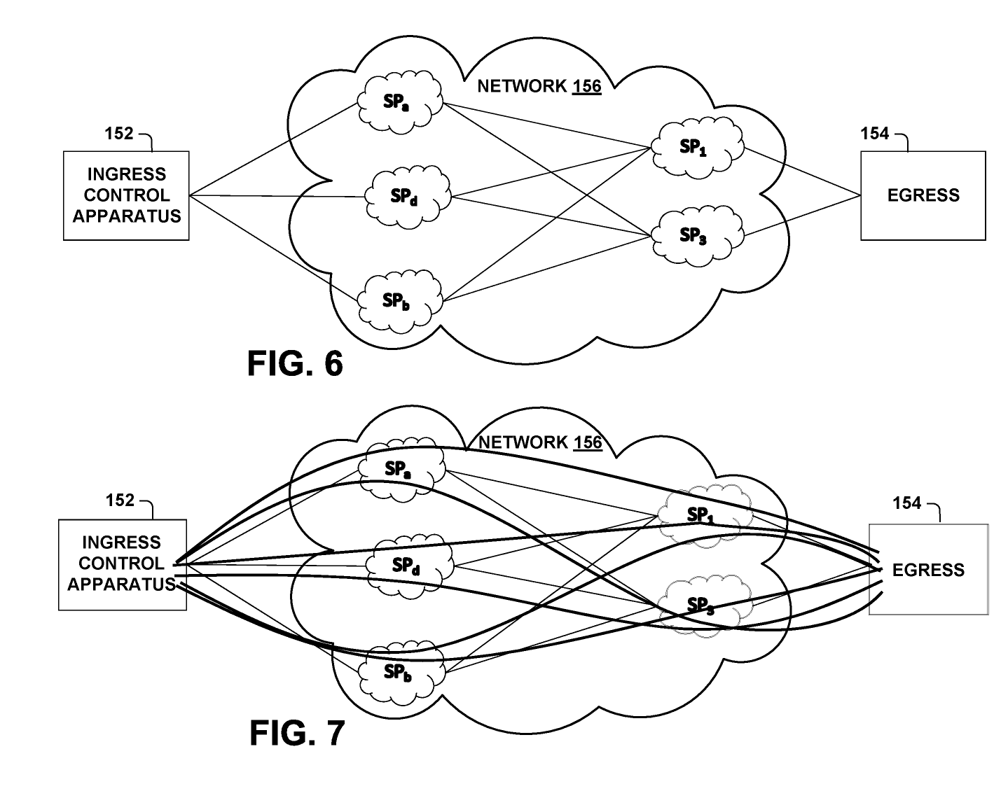

FIGS. 6 and 7 illustrate examples of tunneling that can be implemented between the ingress control apparatus 152 and egress control apparatus 154 of FIG. 5. In the example of FIGS. 6 and 7, it is presumed that the ingress control apparatus implements NICs to access networks maintained by a plurality of service providers (e.g., ISPs), demonstrated at SP_{A} SP_{D}, and SP_{B}. The egress control apparatus 154 implements NICs to access another set of networks to networks demonstrated as SP₁ and SP₃. The combination of networks SP_{A}SP_{D}, SP_{B}, SP₁ and SP₃ collectively define at least a portion of the network 156 of FIG. 5 (the portion exposed directly to each of the ingress and egress control apparatuses 152, 154. In these examples, various connections can exist between respective service provider networks as demonstrated herein, such as can vary according to network peering. Thus, depending upon the network connections, data can travel over a various paths between the ingress control apparatus and the egress control apparatus as well as from the egress control apparatus and the ingress control apparatus.

As demonstrated in the example of FIG. 7, for the example of three network connections at ingress control apparatus 152 and two network connections at egress control apparatus 154, there exists numerous combinations of possible paths between each of the respective service providers (i.e., between each of SP_{A} SP_{D} and SP_{B} and each of SP₁ and SP₃) to route data traffic communicated between the ingress and egress control apparatuses. While each ingress and egress control apparatus 152, 154 can determine to which network each outbound packet is sent, according network assignment methods disclosed herein, the egress and ingress control apparatus cannot control the paths between service provider networks. For example, one or more additional networks (not shown) could exist between and of the service provider networks SP_{A} SP_{D}, SP_{B}, SP₁ and SP3 illustrated in FIGS. 6 and 7, which can add one or more layers of unknown routing paths for data communicated between the respective control apparatuses 152, 154. The particular routing paths through both known and unknown networks collectively affects quality of service for each data packet that is communicated.

Referring back to FIG. 5, the system 150 includes quality management services 170 that can include global analytics 172. Global analytics 172 can include one or more service programmed to perform network analysis for data packets transmitted between each pair of ingress and egress control apparatuses 152, 154. For instance, the analytics 172 can be utilized to compute quality of service with respect to data traffic communicated between ingress and egress control apparatuses 152, 154. As a result, the global analytics can determine which network connection can afford improved network link quality for different types or categorizations of data packets. The network analytics 172 can be similar to the network analysis 80 disclosed with respect to FIG. 3. However, in addition to performing such analytics with respect to high priority traffic sent over any of the network connections between a single set of ingress and egress control apparatuses 152 and 154, the analytics 172 can perform such analysis globally based on traffic communicated across a plurality of different sites, each of which includes at least one ingress-egress control apparatus pair. The global analytics can also perform such analytics on other parts of the network 156, such as the WAN backbone, which can affect traffic quality between ingress and egress apparatuses 152 and 154.

Based on the global analytics 172 operating on a global scale, the quality management services 170 can ascertain actual metrics regarding network speed that spans across multiple different service providers thereby enabling more intelligent usage of network bandwidth for a given network site depending on the particular service provider networks that are implicated for traffic sent through the network 156. For example, the analytics 172 can compute global network metrics for each of the respective service providers. The metrics can be provided to respective link quality managers 162 and 164 of each ingress and egress control apparatus, which metrics can be utilized to enable intelligent network assignment of high priority traffic sessions to those NICs providing network connections predetermined (e.g., by analytics 172) known a priori to provide improved network quality and speed. As mentioned, the aggregate network quality data determined by the global analytics, whether determined for a single site having a plurality of network connections or more globally for a plurality of sites, affords significant advantages since such information is not available to individual service providers. This is generally since different network providers do not tend to share actual network quality and speed information with their competitors.

In addition to creating tunnels for each of the outbound network connections for each ingress and egress control apparatus 152, 154, a separate tunnel can be created as a control channel between the respective control apparatuses, such as a connection between a selected pair of NICs 158 and 160. The control channel can be utilized to send information to facilitate dynamic reassignment and prioritization of outbound data packets for each respective ingress and egress control apparatus 152, 154. In some examples, the control channel (e.g., implemented as a tunnel between the respective egress and ingress control apparatuses associated with a given site) can be an ultra-high priority channel that takes precedence over other data traffic including, in some examples, over the high-priority time sensitive data that is provided to the high priority queues. For instance, a control channel queue thus could be implemented (e.g., in one of the queues 122 of FIG. 4) as the highest priority type of queue. This is because by making the control channel the highest priority, the determination and dynamic (e.g., real-time) reassignment of sessions to different network connections can be facilitated based on the shared metrics relating to network performance. As a result, the available performance, speed and bandwidth provided by the network connections available at each ingress and egress control apparatus 152, 154 can be dynamically utilized more effectively and efficiently to optimize quality of service for higher priority, time-sensitive data traffic.

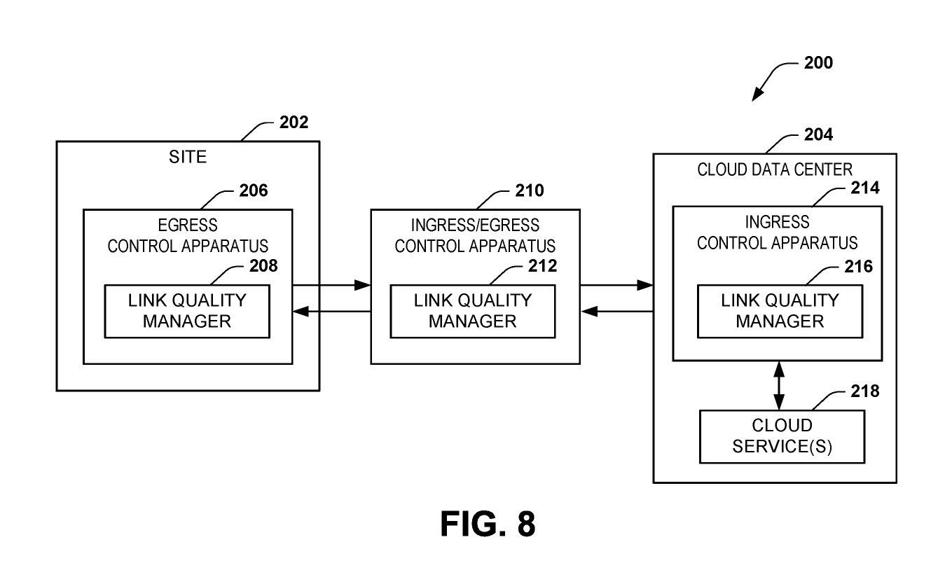

FIG. 8 is a block diagram illustrating an example of a communication system 200 that includes multiple egress/ingress pairs that implement provide multiple stages of bi-directional traffic control between a site 202 and a cloud data center 204. The site 202 includes an egress control apparatus 206 which implements a link quality manager for controlling egress of data traffic with respect to the site, as disclosed herein. As mentioned the site 202 can correspond to an enterprise, such as a business, office or home, or an individual device (e.g., smart phone). The egress control apparatus 206 is connected with an ingress/egress control apparatus 210 via one or more network connections. The ingress/egress control apparatus 210 can be located apart from the site 202, such as in “last mile” connection or within the WAN backbone. From the perspective of the site 202, the ingress/egress control apparatus 210 includes a link quality manager 212 to control ingress of data traffic to the site. Thus, the egress control apparatus 206 and the ingress/egress control apparatus 210 defines an egress/ingress pair that operates to control bidirectional control of traffic therebetween. Various examples of session assignment, session reassignment and prioritization and routing that can be implemented by the egress control apparatus 206 and the ingress/egress control apparatus 210 are disclosed herein (see, e.g., FIGS. 1-7 and the associated descriptions).

The ingress/egress control apparatus 210 is coupled to the cloud data center 204 via one or more network connections. In the example, of FIG. 8, the cloud data center includes an ingress control apparatus 214. The ingress control apparatus 214 may reside in the WAN backbone, within the cloud datacenter or another location near the data center, for example. The ingress control apparatus 214 at the data center 204 includes a link quality manager 212 to control ingress of data traffic to the ingress/egress control apparatus 210, and the ingress/egress control apparatus 210 further is configured to control egress of traffic from the ingress/egress control apparatus 210 to the cloud data center via the network connection(s) therebetween. That is, ingress/egress control apparatus 210 operates as a site apparatus to control egress of data packets from the ingress/egress control apparatus 210. Thus, the ingress/egress control apparatus 210 and the ingress control apparatus 214 define another egress/ingress pair that operates to control bidirectional control of traffic therebetween. Similar to egress/ingress pair 206, 210, the egress/ingress pair 210, 214 controls bidirectional traffic, such as including any of the examples of session assignment, session reassignment and prioritization and routing disclosed herein (see, e.g., FIGS. 1-7 and the associated descriptions). While the example of FIG. 8 demonstrates two egress/ingress pairs for traffic control between the site and the data center 204, there can be any number of two or more such egress/ingress pairs in the traffic path.

By way of example, one or more applications running within the site 202 can subscribe to and implement one or more services 218 provided by the cloud data center 204. As an example, the services 218 implemented in the cloud data center 204 can be considered high-priority, time-sensitive in nature as to be afforded priority over many other categories of data. Thus, the link quality managers 208, 212 and 216 at each stage of the traffic path between the site application and the cloud service 218 can be programmed to prioritize packets communicated to and from the cloud service 218. Each egress/ingress pair can also prioritize other time-sensitive, high-priority packets over lower priority traffic or traffic having no priority, as disclosed herein.

As a further example where multiple network connections exist between respective egress/ingress pairs, tunneling can be utilized to provide each respective connection, as disclosed with respect to FIGS. 5-7. Since multiple tunnels exist between the site and the cloud data center (e.g., one set between egress control apparatus 206 and ingress/egress control apparatus 210 and another set between ingress/egress control apparatus 210 and ingress control apparatus 214), the number of different combinations of potential tunnel paths increases exponentially. Each tunnel can correspond to a respective logical network interface used by kernel level functions for routing each data packet to an assigned tunnel. As a result, further efficiencies can be achieved by selecting various combinations of tunnels for each egress/ingress pair for each respective session. Each tunnel thus can be independently assigned and reassigned for routing data packets for a given session according to capacity and quality measures determined for each respective tunnel, as disclosed herein.

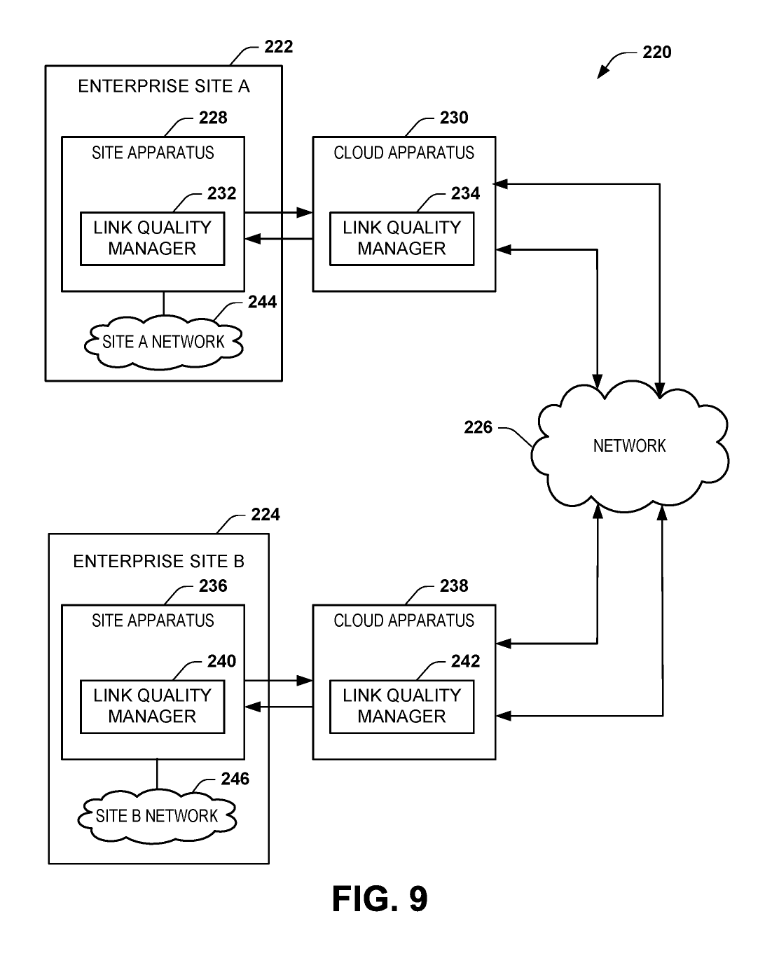

As another example of multiple egress/ingress pairs, FIG. 9 is a block diagram illustrating an example of an enterprise communication system 220. The enterprise system includes multiple egress/ingress pairs connected between different sites 222 and 224 of the enterprise, demonstrated at enterprise site A and enterprise site B. Each site 222, 224 can be part of the enterprise system 220, such as corresponding to an office, a home, or an individual device (e.g., smart phone). While two such sites 222 and 224 are illustrated in the example of FIG. 9, there can be any number of two or more sites to collectively form the enterprise system (or at least a portion thereof). The sites can be distributed across a geographic region, which may include multiple states or even different countries. Each site 222, 224 can utilize an egress/ingress pair to control bidirectional traffic with respect to the respective site, as disclosed herein. There can be additional egress/ingress pairs to control traffic at other parts of a path, such as to a data center as in the example of FIG. 8.

In the example of FIG. 9, the site 222 includes a site apparatus 228 that implements a link quality manager 232 for controlling egress of data traffic with respect to the site 222. The site apparatus 228 is connected with a cloud apparatus 230 via one or more network connections (e.g., wired and/or wireless). The site apparatus 228 and cloud apparatus 230 thus defines an egress/ingress pair to control bidirectional traffic, such as according to any combination of the examples of session assignment, session reassignment and prioritization and routing disclosed herein (see, e.g., FIGS. 1-7 and the associated descriptions). The cloud apparatus 230 thus can be connected to or implemented within the cloud to send and receive traffic via the network 226 on behalf of the site 222. The cloud apparatus 230 can be located apart from the site 222, such as in “last mile” connection or within a WAN backbone of an associated network 226.

The other site 224 is similarly configured to operate in the enterprise system 220. The site 224 includes a site apparatus 236 that implements a link quality manager 240 for controlling egress of data traffic with respect to the site 224. The site apparatus 236 is connected with an associated cloud apparatus 238 via one or more network connections (e.g., wired and/or wireless). The site apparatus 236 and cloud apparatus 238 defines another egress/ingress pair to control bidirectional traffic with respect to the site 224. As mentioned, each of the site apparatus 236 and the cloud apparatus 238 can control sending out data packets to each other over their available network connections according to any combination of the examples of session assignment, session reassignment and prioritization and routing disclosed herein (see, e.g., FIGS. 1-7 and the associated descriptions). The cloud apparatus 230 can be located apart from the site 222, such as in “last mile” connection or within a WAN backbone of an associated network 226 to send and receive traffic via the network 226 on behalf of the site 224.

For the example of inter-site communications between sites 222 and 224, such communication can thus result in communication from one egress/ingress pair to the other egress/ingress pair. In some examples, the bidirectional control between site and cloud apparatuses can be managed as disclosed herein. For communication over the connections between site apparatus 228 and cloud apparatus 230, the cloud apparatus operates as an ingress control apparatus to control traffic sent to the site. At the other site, for communication over the connections between site apparatus 236 and cloud apparatus 238, the cloud apparatus 238 operates as an ingress control apparatus to control ingress traffic being sent to the site 224 and the site apparatus 236 controls egress traffic being sent from the site 224.

By implementing egress/ingress pairs for each site operating in the enterprise system 220, inter-site communication of data traffic can be maintained at a high-level of quality. That is, the benefits result from session assignment, session reassignment and prioritization and routing disclosed herein can be duplicated across multiple connections to increase overall quality of service. Additionally, where multiple network connections exist between respective egress/ingress pairs (between site apparatus 228 and cloud apparatus 230 and between site apparatus 236 and cloud apparatus 238), tunneling can be utilized to provide a selected connection for each session, such as disclosed with respect to FIGS. 5-7. Since multiple tunnels exist between each site apparatus and cloud apparatus, a greater number of tunnel combinations for a given inter-site communication session. Each tunnel thus can be independently assigned and reassigned for prioritized routing data packets for a given session according to capacity and quality measures determined for each respective tunnel, as disclosed herein.

As a further example, each site 222 and 224 can include a respective site network 244 and 246. Each site network 244, 246 can implement services or other resources that can be accessed by an application within the same site as such network or with a different site. For example, an application running in the site 222 can employ an inter-site communication session to access services or other resources implemented by the site network 246. The bidirectional traffic control implemented by each egress/ingress pair affords an increased quality of service. An alternative configuration to a cloud apparatus per enterprise site is to share a single cloud apparatus among a number of sites, as well as a mix of paired sites with associated sharing sites. In addition, a given cloud apparatus can be “multi-tenant” and shared among a number of unrelated enterprise sites or other types of sites.

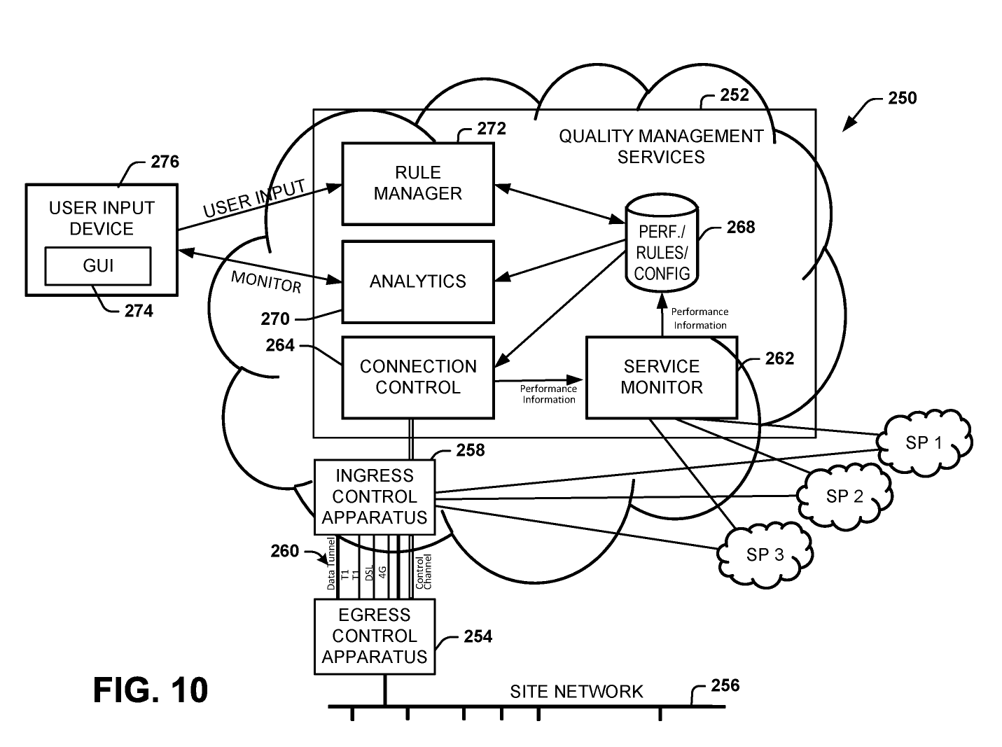

FIG. 10 depicts part of a communication system 250 that includes an example of quality management services 252 for managing bi-directional traffic for one or more sites as disclosed herein. The quality management services 252 can correspond to service 170 described with respect to the example of FIG. 5. The system 250 includes an egress control apparatus 254 at a site (e.g., a customer site) that is connected to a site network 256 (e.g., a local network). A plurality of device (e.g., desktop computers, tablet computers, laptop computers, phones, conferencing systems and the like—not shown) can be connected to the network 256 and run any number and type of applications. Such applications can access resources (e.g., other applications or services) external to the site, such as disclosed herein. The egress control apparatus 254 is further connected to an ingress control apparatus 258 such as can be located in the cloud or other remote location (e.g., last mile connection).

The egress and ingress apparatuses 254, 258 are connected to each other via a plurality of network connections, demonstrated at 260. The physical links that form the set of network connections 260 can be wired connections (e.g., electrically conductive or optical fiber) as well as wireless connections. For example, the network connections 260 can include any combination of physical layer links such as T1, DSL, 4G cellular, or the like. As mentioned above, tunneling can be provided via each link for communicating data packets between each of the control apparatuses 254 and 258. In addition to tunneling to provide logical connections 260 for data traffic, a separate control channel tunnel can be established between the respective apparatuses 254 and 258 via one of the links. Each tunnel can be implemented as a secured communication link or an unsecured communication link. An unsecured communication link can be utilized when sufficient security is implemented by the respective networks and systems to which the ingress control apparatus and egress control apparatus are implemented. Each of the ingress and egress control apparatuses can include link quality managers to control network traffic dynamically, such as disclosed herein.

While the connections 260 between each of the ingress and egress apparatuses 254 and 258 are demonstrated as corresponding through data tunnels that can involve network peering for exchanging traffic between separate internet networks, it is to be understood that each of the respective tunnels can include respective “last mile” network connections provided by respective service providers to the end-user (e.g., customer site) to provide connections to a WAN (e.g., internet) according to a service plan. Additionally, or alternatively, the connections 260 can include the “first mile” near data center (cloud or enterprise) network connections, and/or within the “backbone” providing the long distance network connections. For instance, each of the service plans can provide a minimum or maximum bandwidth designated by each respective service provider according to service plan specification requirements. The amount bandwidth can be may be fixed or variable depending upon network operating parameters and contract requirements usage. In many cases, bandwidth is variable within a range even though some minimum bandwidth may be specified for each end-user's service plan.

In the example of FIG. 10, the ingress control apparatus 258 in the cloud (e.g., public and/or private cloud) is demonstrated as being connected to a plurality of service providers demonstrated as SP1, SP2 and SP3 (e.g., via corresponding network interfaces, such as in FIG. 5). While three service providers are demonstrated in this example, there can be any number of one or more, as determined according to service contracts of the site. The quality management service 252 can further monitor each of the connections to which each of the ingress control apparatus 258 and the egress control apparatus 254 are connected.

For example, the quality management services 252 can include a service monitor 262. The service monitor 262 can monitor aspects of performance for each respective connection via the corresponding service providers SP1, SP2 and SP3. The physical monitoring, for example, can be performed via the ingress control apparatus 254 for each site (e.g., any number of one or more sites) implemented in the system 250. Thus, the service monitor 262 can be implemented in each network interface to provide performance information associated with each network connection (e.g., including bandwidth, network capacity and the like).

Additional performance information for each customer site can be collected at a connection control 264. The connection control 264, for example can provide performance information to the service monitor 262 based upon control and network usage information received from each ingress control apparatus 258 and egress control apparatus 254. For instance, the connection control 264 can operate as a cloud service that communicates with each of the egress and ingress control apparatuses 254, 258 via corresponding control channel (e.g., via secure or unsecure tunneling). As mentioned, the control channel can correspond to a highest priority channel implemented via tunneling between egress and ingress control apparatuses 254, 258 to ensure that the control information is continuously fed to the connection control 264. In some examples, a separate connection can be made between the egress control apparatus 254 and the connection control, such as a dedicated secure tunnel. The performance information for the egress and ingress control apparatus 254 and 258 operating for the site and performance information collected by the service monitor 262 for each network can be stored in a database 268.

An analytics service 270 is programmed to compute various performance metrics, including global metrics for each service provider's network and/or local metrics associated with each respective site. The analytics service 270 thus can correspond to a cloud implementation of the analytics 172 described with respect to FIG. 5. The performance metrics can include current and historical global performance data for each network SP 1, SP 2 and SP 3 that is utilized by the egress and ingress control apparatus 254 and 258 for each site implemented in the system 250. As mentioned, there can be any number of sites, each having an egress/ingress pair, as well as other egress/ingress pairs at other network locations. Additionally, the analytics service 270 can compile and compute performance metrics for data traffic communicated between the egress and ingress control apparatus 254 and 258 for each respective site. For example, an authorized user can employ the GUI 224 running at a user input device (e.g., computer or other device) 276 to access the analytics service 220 to select a set of metrics associated with a particular site or portion of the site. In response to the user query via the GUI 224, the analytics 220 can access the database 268, compute one or more selected performance metrics and display the requested user information (e.g., a performance dashboard) at the GUI.

The performance metrics, for example, can provide an indication of actual network bandwidth utilized in a time interval and/or for one more network connections. The performance metric can also be computed for one or more type of traffic identified by the user (e.g., in response to a user input), such as corresponding to high-priority traffic, to provide an indication of network performance related to specific type of traffic selected. In some cases, the GUI can be utilized to ascertain information for each service provider's network (e.g., statistical performance information) based on the aggregated performance information collected for each of the plurality of sites. Such global network information can enable users to understand capacity and performance metrics among a plurality of different service providers.

Additionally, the configuration and corresponding functions implemented by each egress and ingress control apparatus 254 and 258 can be set by the quality management services 252. For example, a rule manager service 222 can define the rules and configuration information for the egress and ingress control apparatus 254 and 258 at each site in response to user input (e.g., entered by an authorized site administrator via GUI 224). The rules and configuration data for each site can be stored in the database 268. The rules and performance configuration data stored in the database 268 for each site can be updated dynamically during system operation, such as in response to user input modifying rules or adding new network connections. The connection control service 264 in turn can provide configuration information to program each respective apparatus 254, 258, which can include specifying what network analysis information is shared between the ingress and egress control apparatuses via the logical control channel, as to provide cooperation in measuring bandwidth. Connection control 264 can also perform path changes for one or more sessions based on the analytics 270 (e.g., jitter, latency and/or packet loss).

By way of example, a user can employ a GUI 274 to identify and define which types of information and data traffic are considered to be high priority, different levels of priority may be established by the administrator in response to user input. As a further example, the configuration information can include IP address for each of the ingress and egress control apparatus as well as specific resource location identifiers (e.g., URLs) to enable tunneling to be established and maintained between egress and ingress control apparatuses 254, 258. The rules manager 222 can in turn update and modify the rules in the rule and configuration data in the database 268. If rules and/or configuration information changes for a given site, updated rules and configuration information can be provided to a given egress and/or control apparatus consistent with the updates.

During operation, the quality management services 252 can further employ the analytics service 220 to monitor the rules and performance and configuration data in the database 268 to determine an indication of performance for the aggregate set of connections 260 between the ingress and egress control apparatus 258 and 254, respectively. For instance, the indication of performance can indicate performance metrics with respect to the outbound traffic that is sent from each control apparatus 254, 258 to the other via the aggregate tunnel provided by network connections 260. The analytics service 270 thus can monitor the performance and configuration information that is acquired over time to determine whether any changes may be needed to the rules and configuration information stored in database 268. Any changes to the rules and configuration data 268 can be provided to the connection control 264 for updating the ingress control apparatus 258 and egress control apparatus 254, such as via a corresponding control channel. Additionally, far end quality analysis for one or more sites can be provided to the analytics service 270, which can help determine whether path changes may be needed for any sessions. The analytics service 270 can also determine an indication of capacity and/or quality of service for one or more network connections, which can be sent to ingress and egress control apparatuses via the control channel (or other connection) and utilized to control initial session assignment as well as reassignment.

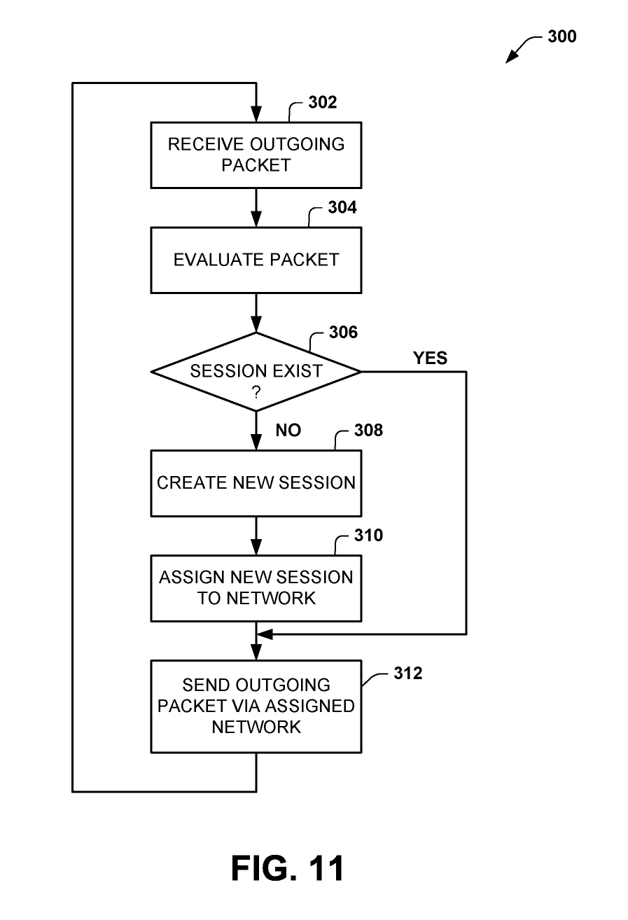

In view of the structural and functional features described above, certain methods will be better appreciated with reference to FIGS. 11, 12 and 13. It is to be understood and appreciated that the illustrated actions, in other embodiments, may occur in different orders or concurrently with other actions. Moreover, not all features illustrated in FIGS. 11, 12 and 13 may be required to implement a method. It is to be further understood that the following method can be implemented in hardware (e.g., one or more processors, such as in a computer or computers), software (e.g., stored in a computer readable medium or as executable instructions running on one or more processors), or as a combination of hardware and software.

FIG. 11 is a flow diagram illustrating an example method 300 for network transport and session link assignment, such as can be implemented by session network assignment control 56 (e.g., see FIGS. 2 and 3). The method begins at 302 in which an outgoing data packet is received. The packet is received during corresponding interface to kernel level transport functions (e.g., placed in the IP stack via API) such as disclosed herein.

At 304, the received outgoing packet is evaluated. The evaluation can be based upon header information in the packet such as sufficient to describe a session (e.g., source IP address, source port, destination address, destination port, and protocol). Based on the evaluation at 304, a determination is made at 306 as to whether a session already exists for the received and evaluated packet. If no session already exists at 306, the method proceeds to 308. At 308 a new session is created. Creating a new session can include creating an entry in a session table (or other data structure stored in memory) that specifies a session according to the session-identifying data evaluated at 304.

At 310, the new session is assigned to a network. The network assignment for a given session can be made (e.g., by session network assignment control 56) according to various methods as disclosed herein. For example, the session assignment can be based on a simplified round-robin approach to which the session is assigned to one of a plurality of available networks. In other examples, the assignment can be based on network capacity or other network analysis (e.g., network analysis 80), as disclosed herein. In some examples, available network capacity for each of the available network connection for the ingress and egress control apparatus can be calculated by determining network saturation and a capacity calculator (e.g., capacity calculator 80) can determine remaining capacity for each network connection. As another example, a passive measurement of capacity can be determined by calculating a queue sojourn time such as to ascertain which network has the most unused capacity. For instance, the network having the shortest sojourn time a given queue (e.g., one of the high-priority queues) can indicate such network as having the most unused network capacity. The queue sojourn time that data travels through a path within a given control apparatus may be determined differently for different types of packets and protocols. As mentioned, the categorization of packets may be determined based on the packet evaluator at 304 or other methods disclosed herein, which may be implemented by kernel-level code and/or by user-level code via an interface. As another example, the assignment at 310 can be based upon a weighted round robin or the weight is adjusted according to network available capacity such as according to the approaches disclosed herein.

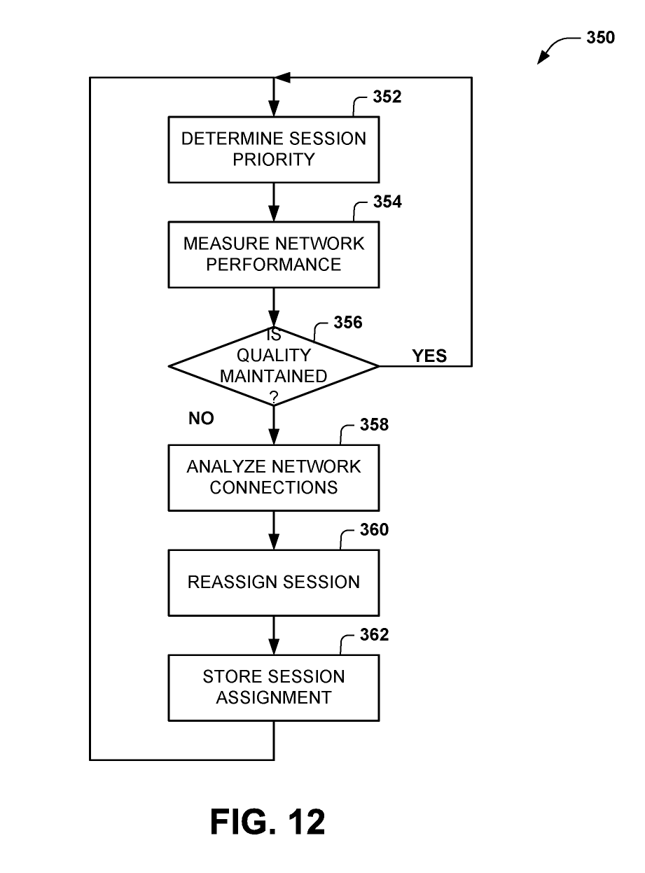

As an example, the capacity for a given network connection can be a variable parameter. For example, the capacity can be set to a default level in each direction with respect to the egress and ingress control apparatuses. The capacity can be decreased in response to one or more quality measures, as disclosed herein, indicating quality is below a threshold level. The capacity thus can be decreased until quality issues no longer exist. The capacity can also be adjusted upward (e.g., increased) if there are no capacity decreases made during a prescribed time interval. The session assignment at 310 for a new session as well as subsequent session reassignment (see FIG. 12) thus can evaluate the variable capacity in each upstream and downstream direction for respective network connections in determining to which network connection the session will be assigned.

If a session already exists at 306 and subsequent to assigning the session for the received packet to a network (at 310), the session proceeds to 312 in which the outgoing packet is sent via its assigned network. The network assignment of each session is maintained for the life of the session, which can vary largely depending on the type of traffic. In this way, all subsequent packets for a given session remain over the same network connection, unless the session is reassigned (see, e.g., FIG. 12).

FIG. 12 is a flow diagram illustrating an example method 350 for reassigning a session from one network to another. The method 350 begins at 352 by determining a priority of packets. Thus, the method 350 can be utilized to reassign network connections for sessions that include a type of data packets determined (e.g., based on rules applied by packet evaluator 70, 110) to be of sufficiently high priority. In some examples, there can be two levels of priority (e.g., high and low) for categorizing outgoing data packets. In other examples, one or more types of outgoing data packets can be categorized as a single high priority level, while other types of packets are categorized into one or more other lower priority levels. In this way the prioritization of packets for a given session can be used to define the session priority at 352. As disclosed herein, the categorization of the outgoing data packets is used to place each outgoing data packet into an appropriate priority level queue and, in turn, send the respective packet out via the associated network connection to which the session is currently assigned (see, e.g., FIG. 11).

At 354 network performance is measured. The measure of network performance can be implemented according to one or more various approaches disclosed herein. For example, the measure of network performance can be a passive measurement that does not involve extra transmission of data to perform the measurement. Passive measurement, for example, may involve calculating a sojourn time of data packets for a given session through a path that exists within a given ingress or egress control apparatus. Sojourn time can be computed based on counting clock signals from when an outbound packet for given session enters the IP stack through a time when it is sent out of a given high priority queue over its assigned network. A threshold can be established to provide a range of sojourn time that indicates a sufficiently good quality. In some cases, traffic can be busy such that the sojourn time may need to be measured for a plurality of data packets of the given high priority session over a time interval (e.g., multiple seconds).

Additionally, or alternatively, the measure of network performance for a given session can include one or more active measurements. As mentioned, an active measurement can include monitoring communication across a portion of a network. For example, an active measurement can be implemented by pinging a predetermined resource location (e.g., a server, such as google.com) in the cloud in which the ping is sent through the assigned network connection for a given session. Another active measurement technique to provide an indication of quality for voice or other high-priority data traffic is to measure jitter. For example, far end jitter can be measured for a critical session (e.g., session determined at 352 as having a high priority) such as by the ingress control apparatus receiving the data packet that is transmitted as the outbound data from the egress control apparatus using a particular protocol, and is sent back to the egress control apparatus. In the other direction, the measurement packet(s) are sent from the ingress control apparatus (e.g., apparatus 258) to the egress control apparatus (e.g., apparatus 254) and returned from the egress apparatus back to the ingress control apparatus via a corresponding link. In one example, the egress control apparatus analyzes latency, jitter, and loss for the downstream part of a given session, and a protocol from the ingress control apparatus via any of the service provider networks (e.g., SP 1, SP 2, SP 3) can be utilized to ascertain similar network characteristics on the upstream part of the given session. The jitter thus can be computed with respect to the arriving traffic, which further can be compared to a corresponding jitter threshold to provide a measure of network performance for session traffic. Such analysis to measure performance can be implemented with respect to each ongoing session, for example, which has been determined to be high priority.

Based upon the measured network performance and applicable thresholds, a determination can be made at 356 whether the quality is maintained for a respective session. If the quality is determined at 356 to be not maintained, the method continues at 358 to implement a reassignment. As mentioned, the determination of quality for a given network connection can be based on passive and/or active measurements. For the example where the measured network performance includes sojourn time (e.g., a passive measure), if the sojourn time exceeds the established threshold time, and poor quality can be identified and utilized to determine (at 356) that sufficient quality is not being maintained for the session as to trigger session reassignment.

At 358, the available networks can be analyzed such as including analysis of available network capacity for sending outbound data packets for a given session. Based upon the analysis at 358, the method proceeds to 360 in which the corresponding session is reassigned to a new available network. The assignment can be based on the available capacity such as can be determined by a capacity calculator (e.g., capacity calculator 82 of FIG. 3; similar to assignment at 310 of FIG. 11). The session can be reassigned by updating the session assignment data at 362. After completing the reassignment process at 362, the method can return to 352 to monitor data packets and identify the high priority packets. Similarly, if it is determined at 356 that sufficient quality is maintained for a given session, the method can proceed from 356 back to 352. The method can run and update the assignment data dynamically based upon the method 350. The method 350 can be implemented with respect to each session to enable reassignment of high-priority sessions from one network connection to another.

FIG. 13 depicts an example of a method 400 for localizing quality issue associated with incoming traffic. At 402, the method includes receiving, at a recipient, incoming traffic from a sender. In the example of FIG. 13, the recipient is either a site apparatus or a remote apparatus, where the site apparatus and the remote apparatus define an egress-ingress pair of apparatuses for a given site that communicate via at least one bi-directional network link between the egress-ingress pair. The site apparatus controls egress of data traffic with respect to the given site and the remote apparatus controls ingress of data traffic with respect to the given site.

At 406, the incoming traffic at the recipient (from the sender) or outgoing traffic (to the sender) is analyzed to identify a quality issue associated with the traffic. The analysis (at the recipient) can include various types of analysis of network traffic, such as disclosed with respect to network analysis 80 of FIG. 3. The analysis can include determining latency, jitter loss for packets in the incoming traffic from the sender or retransmissions to the sender. As a further example, the analysis can vary depending on the type of traffic, which can be determined by packet evaluation (e.g., by packet evaluator 70). Thus, by identifying a type of the incoming traffic different forms of analysis can be performed. For example, if the type of the incoming traffic is UDP traffic, the analysis at 406 can include calculating jitter, latency and/or loss for the UDP traffic. Such calculated quality parameter thus can be used to quantify the quality issue and, such as by comparing the calculated value or values with respect to a corresponding threshold. The result of such comparison indicates that the calculated value(s) exceeds a threshold, it can be used to trigger appropriate action (e.g., changing a path of for connection).

As another example, the analysis at 406 can include analyzing outgoing traffic from the recipient, including to determine a type of the outgoing traffic. For instance, if the type of the outgoing traffic is TCP traffic, the analysis at 406 can include monitoring re-transmissions in the TCP traffic, such as to indicate a quality issue associated with connection via which the outgoing traffic is being provided. Other approaches for quality analysis, including those disclosed herein may be employed at 406.

At 408, the method also includes determining a location for the quality issue. For instance, the method can determine that the identified quality issue pertains to the one bi-directional link between the egress-ingress pair. Alternatively, at 408, it can be determined that the identified quality issue pertains to resources external to the at least one bi-directional link between the egress-ingress pair. In response to determining that the identified quality issue pertains to one or more sessions of traffic being sent over a given one link between the egress-ingress pair, at 410, the path for such session of traffic between the recipient and the sender can be changed to another existing connection for the site. For example, the traffic medication can include reassigning a session to a different network link and/or changing a priority of data packets associate with a given session, such as disclosed herein.

In response to determining that the identified quality issue pertains to resources external to the at least one bi-directional link between the egress-ingress pair, at 412 a notification can be sent to a predetermined entity associated with the given site. The notification, for example, can be sent to one or more network administrator (e.g., as an email, text message or other form of communication). The notification further can identify a location for the identified quality issue with greater specificity, which may be determined based on the identity of the sender. For example location for the identified quality issue that is not part of the link between the egress-ingress pair may reside at one or more of within the given site, within a last mile connection, within network backbone, and in a first mile, the notification specifying the determined location.

In some examples, the sender is an apparatus or application outside the given site, and the recipient implementing the method 400 has multiple connections to the external apparatus or application, one of which is being used as a path to communicate one or more session of traffic from the recipient to the external sender. In this example, in response to determining that the identified quality issue pertains to the traffic external to the egress-ingress pair, at 414, a path for the at least one session of traffic that is being communicated from the recipient to the sender can be changed. The change can be implemented by moving the session from its current connection to another of the multiple connections, such as by reassigning the session to a corresponding network interface associated with the other connection. The change can be implemented in combination with or in place of the notification that is sent at 412.

As a further example, the remote ingress apparatus of the egress-ingress pair is located at a service provider network hub associated with a data center that provides a service accessed by the given site via the one or more links between the site apparatus and remote apparatus. In this example, based on the location of the ingress apparatus, the identified quality issue can be determined to pertain to the service being provided by the data center and/or a communication link between the network hub and the service provided by the data center. Thus, in response to determining that the identified quality issue pertains to at least one of the service provided by the data center or the communication link between the network hub and the service, the notification can be sent at 412 to one or more predetermined entities associated with the data center or service provider. The notification further can trigger an additional inquiry to a known administrator via an external communication mode (e.g., email, telephone call or the like) to confirm health status of the communication link between the network hub and the service, such as in response to the notification. The additional inquiry thus can help further localize the quality issue by ascertaining whether the identified quality issue pertains to either an application in the data center or the communication link itself.

As will be appreciated by those skilled in the art, portions of the systems and methods disclosed herein may be embodied as a method, data processing system, or computer program product (e.g., a non-transitory computer readable medium having instructions executable by a processor). Accordingly, these portions of the invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments are disclosed herein with reference to flowchart illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in a non-transitory computer-readable medium that can direct a computer or other programmable data processing apparatus (e.g., one or more processing core) to function in a particular manner, such that the instructions stored in the computer-readable medium result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks or the associated description.

What are disclosed herein are examples. It is, of course, not possible to describe every conceivable combination of components or methods, but one of ordinary skill in the art will recognize that many further combinations and permutations are possible. Accordingly, the disclosure is intended to embrace all such alterations, modifications, and variations that fall within the scope of this application, including the appended claims.

As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method, comprising:
storing, in non-transitory memory, prioritization rules that establish a priority preference for egress of data traffic for a first location, the first location including a first location apparatus to control egress of data traffic for the first location apparatus and a second location apparatus at a second location, which is different from the first location, to receive data traffic and cooperate with the first apparatus to measure bandwidth with respect to the first location, the first location apparatus being coupled with the second location apparatus via at least one bidirectional network connection;
estimating capacity of the at least one network connection for the egress of data traffic with respect to the first location;
categorizing each packet in egress data traffic from the first location based on an evaluation of each packet with respect to the prioritization rules;
placing each packet in one of a plurality of egress queues associated with the at least one network connection at the first location apparatus according to the categorization of each respective packet and the estimated capacity; and
sending the packets from the first location apparatus to the second location apparatus via a respective network connection according to a priority of the respective egress queue into which each packet is placed, such that the first location apparatus transmits at the estimated capacity for the egress of data traffic.

2. The method of claim 1, wherein measuring capacity is performed to provide a current estimate of capacity for the egress of data traffic with respect to the first location, the first location apparatus transmitting at the current estimate of capacity for the egress of data traffic.

3. The method of claim 2, wherein each of the plurality of queues associated with the at least one network connection is assigned different priority for sending different priority egress data traffic from the first location, the method further comprising:
setting a rate limit for the at least one network connection based on the current estimate of capacity thereof;
controlling throughput of data traffic for each of the plurality of queues of a given network connection by reducing throughput of traffic for at least one lower priority queue of the given connection if an aggregate throughput for the given network connection exceeds the rate limit thereof while maintaining throughput of at least one higher priority queue of the given network connection.

4. The method of claim 1, wherein the first location apparatus and/or the second location apparatus is virtualized in a cloud.

5. The method of claim 1, further comprising dropping a next packet from a given one of the plurality of egress queues at the first location apparatus to meet the estimated capacity.

6. The method of claim 1, wherein the method further comprises:
evaluating data packets to determine a behavior of the data traffic based on at least one of an internet protocol, a DNS request, port number or differentiated services code; and
wherein the categorizing the data packets is performed based on the determined behavior.

7. The method of claim 6, further comprising marking the packet with metadata to specify the determined behavior of the data traffic and a respective network interface to which the given session has been assigned, wherein the evaluating, categorizing and marking are performed via machine readable instructions of the first location apparatus executing within the operating system kernel and/or by a user-level application.

8. The method of claim 1, wherein the at least one network connection comprises a plurality of network connections for the egress of the data traffic with respect to the first location,
wherein the first location apparatus includes a respective network interface for communicating the data traffic via each of the plurality of network connections, each of the respective network interfaces including a respective set of different priority network queues, the method further comprising:
assigning each session of data traffic to one of the plurality of network interfaces;
storing network assignment data to specify which of the plurality of network connections each session of data traffic is assigned;
identifying a session of data traffic for each of the data packets; and
selectively routing each of the data packets to its assigned network interface via the respective set of network queues thereof according to the network assignment data for the identified session of data traffic.

9. The method of claim 8, wherein the method further comprises:
evaluating each packet to identify the session of data traffic to which each respective packet is assigned based on a session tuple that includes at least four of a source internet protocol (IP) address, a source port, a destination IP address, a destination port, a DNS query and a network protocol thereof the respective packet.

10. The method of claim 8, wherein estimating capacity further comprises estimating capacity of each of the plurality of network connections for the egress data traffic, each session of data traffic being assigned to one of the plurality of network interfaces based on the estimated capacity for each of the plurality of network connections.

11. The method of claim 10, wherein the estimated capacity for the plurality of network connections is at least one of a predetermined static bandwidth for each respective network connection or a dynamic bandwidth that is determined based on a measured downstream throughput and a quality metric for each respective network connection.

12. The method of claim 10, further comprising applying a weighting to each of the plurality of network connections according to the estimated capacity thereof, each session of data traffic being assigned to one of the plurality of network interfaces that is selected based on the weighted estimate of capacity for each of the respective network connections.

13. The method of claim 10, wherein the method further comprises:
setting a rate limit for each of the plurality of network connections based on the estimated capacity thereof; and
controlling throughput of data traffic for each of the plurality of queues of a given network connection, wherein throughput of traffic for at least one lower priority queue of the given connection is reduced in response to detecting that an aggregate throughput for the given network connection exceeds the rate limit thereof while maintaining throughput of at least one higher priority queue of the given network connection above a minimum throughput for the higher priority queue.

14. The method of claim 1, further comprising:
receiving, at the second location apparatus, a set of packets from the first location apparatus via a given network connection;
computing a quality metric of the received packets at the second location apparatus that is determined based on at least one of latency, jitter and packet loss; and
providing the first location apparatus with feedback based on the quality metric;
modifying, at the first location apparatus, a dynamic value of the estimated capacity for the given network connection in response to the feedback,
wherein, based on the dynamic value, at the first location apparatus, the method further includes at least one of:
reassigning one or more sessions of the egress data traffic to a different network interface of the first location apparatus,
changing the priority of one or more sessions of the data traffic, and/or
adjusting a rate limit for egress of the data traffic via the given network connection.

15. An egress apparatus, comprising:
non-transitory memory to store data, the data including machine readable instructions and prioritization rules that establish a priority preference for egress of data traffic for a first location, the first location including the egress apparatus to control egress of data traffic for the first location apparatus and an associated apparatus at another location, which is different from the first location, the associated apparatus to receive data traffic and cooperate with the egress apparatus to measure bandwidth with respect to the first location, the first location apparatus being coupled with the associated apparatus via at least one network connection;
one or more processors to access the memory and execute the instructions, the instructions comprising:
a packet evaluator to evaluate outbound data packets in outbound data traffic from the egress apparatus;
a capacity calculator to estimate capacity for each of the at least one network connections available for the outbound data traffic;
a packet categorizer to categorize each of the outbound data packets based on the packet evaluation thereof with respect to the prioritization rules; and
packet routing control to place each of the outbound data packets in one of a plurality of egress queues at the egress apparatus according to the categorization of each respective packet and the estimated capacity to thereby control sending outbound packets from the egress apparatus to its associated apparatus at the estimated capacity via the at least one network connection according to the priority of the respective egress queue into which each of the outbound packets is placed.

16. The egress apparatus of claim 15, wherein the capacity calculator continually provides the estimated capacity to provide a current estimated of capacity for the egress of data traffic with respect to the first location, the egress apparatus transmitting at the current estimated capacity for the egress of data traffic.

17. The egress apparatus of claim 15, wherein one or both of the egress apparatus and its associated apparatus is virtualized and residing in a cloud.

18. The egress apparatus of claim 15, wherein the at least one network connection comprises a plurality of network connections,
wherein the capacity calculator determines the estimated capacity according to at least one of a static bandwidth or a dynamic bandwidth for each of the plurality of network connections,
the egress apparatus further comprising:
session network assignment control to determine to a session to which each outbound data packet belongs and to assign each session to one of the plurality of network connections based on the estimated capacity,
wherein session network assignment control further comprises a session packet evaluator to evaluate each outbound data packet and determine a session to which each respective outbound data packet has been assigned and to store network assignment data specifying which of the plurality of network connections each session of data traffic is assigned, the session network assignment controls sending outbound data packets from the egress apparatus to the associated apparatus via a given one of the plurality of network connections identified by the packet evaluator based on the network assignment data, such that all outbound data packets associated with each respective session are sent via a common network connection to which each session is assigned.

19. The egress apparatus of claim 18, wherein a set of multiple egress queues having different priorities are associated with each of the plurality of network connections,
wherein the packet evaluator identifies a corresponding network session having high-priority packets, the session network assignment control further comprising:
a session capacity calculator to measure network performance for at least a given one of the plurality of network connections to which the corresponding network session is assigned; and
session link assignment function to reassign the corresponding network session from a given network connection to another one of the plurality of network connections in response to the session capacity calculator determining that quality of the given one of the plurality of network connections is not within expected operating parameters, the session link assignment updating the network assignment data to associate the other one of the plurality of network connections with the corresponding network session.

20. The system of claim 18, wherein the at least one network connection comprises a plurality of network connections,
wherein the capacity calculator determines the estimated capacity for the plurality of network connections as at least one of a predetermined static bandwidth for each respective network connection, an upstream bandwidth or the dynamic bandwidth that is determined based on a measured downstream throughput and a quality metric for each respective network connection.

21. The system of claim 20, further comprising applying a weighting to each of the plurality of network connections according to the estimated capacity thereof, each session of data traffic being assigned to one of the plurality of network interfaces that is selected based on the weighted estimate of capacity for each of the respective network connections.

22. The system of claim 15, wherein the at least one network connection comprises a plurality of network connections,
wherein each network connection of the egress apparatus comprises a respective network interface,
wherein the egress apparatus further comprises a set of network queues associated with each of its network interfaces, each queue having a different priority used by the network interface for sending the outbound data packets over the associated network, the instructions further configured to:
set a rate limit for the at least one network connection based on a current estimate of capacity thereof;
control throughput of data traffic for each of the plurality of queues of a given network connection by reducing throughput of traffic for at least one lower priority queue of the given connection if an aggregate throughput for the given network connection exceeds the rate limit thereof while maintaining throughput of at least one higher priority queue of the given network connection.

23. The system of claim 15, wherein the packet evaluator is further programmed to evaluate the outbound data packets to determine a behavior of a data traffic session for each of the data packets based on at least two of a source internet protocol (IP) address, a source port, a destination IP address, a destination port, a DNS query, a differentiated services code and a network protocol thereof the respective packet, the packet categorizer categorizing each of the outbound data packets based on the behavior of the data traffic session.
